(19) United States
(12) Patent Application Publication
(10) Pub. No.: US 2021/0108628 A1
(43) Pub. Date: Apr. 15, 2021

(54) LINEAR COMPRESSOR

(71) Applicant: LG Electronics Inc., Seoul (KR)

(72) Inventors: Kyunyoung LEE, Seoul (KR); Youngmun LEE, Seoul (KR); Donghan KIM, Seoul (KR); Kiwon NOH, Seoul (KR); Eonpyo HONG, Seoul (KR)

(21) Appl. No.: 16/943,810

(22) Filed: Jul. 30, 2020

(30) Foreign Application Priority Data
Oct. 14, 2019 (KR) 10-2019-0126895

(51) Int. Cl. F04B 39/06; F04B 35/04; F25B 31/02; F04B 39/00

(52) U.S. Cl. CPC F04B 39/066; F04B 35/045; F04B 53/20; F04B 39/0005; F25B 31/023

(57) ABSTRACT

A linear compressor includes a cylinder, a frame, and a discharge unit. The frame includes a discharge frame surface coupled to the discharge unit and a gas hole recessed from the discharge frame surface. The discharge unit includes a bearing refrigerant passage extending toward the gas hole so that a portion of the refrigerant flowing into the discharge space flows into the gas hole.

### CROSS-REFERENCE TO RELATED APPLICATION

The present application claims priority under 35 U.S.C. 119 and 35 U.S.C. 365 to Korean Patent Application No. 10-2019-0126895, filed on Oct. 14, 2019, which is hereby incorporated by reference in its entirety.

### BACKGROUND

The present disclosure relates to a linear compressor.

In general, compressors are machines that receive power from a power generation device such as an electric motor or a turbine to compress air, a refrigerant, or various working gases, thereby increasing a pressure. Compressors are being widely used in home appliances or industrial fields.

Compressors are largely classified into reciprocating compressors, rotary compressors, and scroll compressors.

In such a reciprocating compressor, a compression space, in which a working gas is suctioned or discharged, is provided between a potion and a cylinder so that a refrigerant is compressed while the piston linearly reciprocates within the cylinder.

In addition, in such a rotary compressor, a compression space, in which a working gas is suctioned or discharged, is provided between a roller that rotates eccentrically and a cylinder so that a refrigerant is compressed while the roller rotates eccentrically along an inner wall of the cylinder.

In addition, in such a scroll compressor, a compression space, in which a working gas is suctioned and discharged, is provided between an orbiting scroll and a fixed scroll so that a refrigerant is compressed while the orbiting scroll rotates along the fixed scroll.

In recent years, a linear compressor, which is directly connected to a driving motor, in which a piston linearly reciprocates, to improve compression efficiency without mechanical losses due to motion conversion and has a simple structure, is being developed.

The linear compressor suctions and compresses a refrigerant within a sealed shell while a piston linearly reciprocates within the cylinder by a linear motor and then discharges the compressed refrigerant.

Here, the linear motor is configured to allow a permanent magnet to be disposed between an inner stator and an outer stator. The permanent magnet is driven to linearly reciprocate by electromagnetic force between the permanent magnet and the inner (or outer) stator. Also, since the permanent magnet is driven in a state where the permanent magnet is connected to the piston, the permanent magnet suctions and compresses the refrigerant while linearly reciprocating within the cylinder and then discharge the compressed refrigerant.

In relation to the linear compressor having the above-described structure, the present applicant has field a prior art document 1.

<Prior Art Document 1>

1. Patent Publication Number: 10-2017-0124903 (Date of Publication: Nov. 13, 2017)

2. Tile of the Invention: LINEAR COMPRESSOR

In the prior art document 1, disclosed is a linear compressor including a frame coupled to a cylinder, a gas hole defined in the frame, and a gas pocket communicating with the gas hole to transfer a refrigerant gas into the cylinder. The refrigerant gas may function as a gas bearing between the cylinder and the piston to reduce frictional force due to the reciprocation motion of the piston.

Here, the linear compressor disclosed in the prior art document 1 has the following limitations.

(1) The refrigerant flowing into the gas hole defined in the frame is transferred from a discharge unit. That is, the refrigerant gas supplied through the gas hole corresponds to a high-temperature refrigerant compressed in a compression space.

The refrigerant transferred from the discharge unit to the frame side flows along a front surface of the frame to flow into the gas hole. That is, there is a limitation in that the high-temperature refrigerant flows between the discharge unit and the frame to transfer heat to the frame.

(2) Also, as the heat is transferred from the frame to the piston and the cylinder, the suction refrigerant flowing inside the piston is overheated. Thus, the suction refrigerant may increase in volume to deteriorate compression efficiency.

In particular, the refrigerant gas supplied through the gas hole corresponds to a refrigerant discharged directly from the compression space. Thus, since the refrigerant has a very high temperature, there is a limitation of transferring relatively much heat to the suction refrigerant.

(3) Also, as the refrigerant discharged from the compressed space flows into the discharge cover, the discharge cover is overheated. Also, the heat of the discharge cover is conducted to the frame, and the heat is transferred from the frame to the piston and cylinder.

Particularly, there is a limitation in that the frame, the piston, and the cylinder are disposed to contact each other so that the heat of the frame is easily transferred to the piston and the cylinder by the conduction.

### SUMMARY

Embodiments provide a linear compressor in which a portion of a refrigerant flowing into a compression space so as to be used as a bearing refrigerant is directly transferred to a gas hole without flowing between a frame and a discharge cover.

Embodiments also provide a linear compressor in which a constituent extending to a gas hole is provided in a discharge plenum disposed inside a discharge cover so that a refrigerant effectively flows into the gas hole.

Embodiments also provide a linear compressor in which a discharge plenum that is disposed in close contact with a discharge cover is provided to prevent a frame from increasing in temperature due to a refrigerant discharged from a compression space.

In a linear compressor disclosed in this specification, a bearing refrigerant provided from a discharge unit to a cylinder and a piston by passing through a frame may flow at the shortest distance. Particularly, the bearing refrigerant may be prevented from flowing into the gas hole after flowing along a front surface of the frame.

Thus, the discharge unit may be provided with a refrigerant passage that extends toward the gas hole. Also, the bearing refrigerant passage may be provided in front of the gas hole in an axial direction. That is, the bearing refrigerant passage may be disposed at the shortest distance from the gas hole.

Particular implementations of the present disclosure described herein provide a linear compressor that includes a cylinder, a frame, and a discharge unit. The cylinder defines a compression space configured to compress a refrigerant. The frame may receive the cylinder. The discharge unit defines a discharge space configured to discharge the refrigerant from the compression space. The frame may include a discharge frame surface connected to the discharge unit, and a gas hole defined at the discharge frame surface. The discharge unit may include a bearing refrigerant passage extending toward the gas hole of the frame and configured to permit a portion of the refrigerant to flow from the discharge space to the gas hole.

In some implementations, the linear compressor described herein can optionally include one or more of the following features. At least a portion of the bearing refrigerant passage may be disposed in the gas hole. The discharge unit may include a discharge cover connected to the discharge frame surface, and a discharge plenum received in the discharge cover and including a bearing refrigerant hole that defines at least a portion of the bearing refrigerant passage. The discharge plenum may include a plenum flange extending in a radial direction and received in the discharge cover. The bearing refrigerant hole may be defined at the plenum flange. The discharge plenum may include a plenum guide surface extending from the plenum flange and defining the bearing refrigerant hole. The bearing refrigerant passage may extend through the plenum guide surface. The plenum guide surface may extend from opposite sides of the plenum flange. The linear compressor may include a bearing refrigerant pipe that is inserted into the bearing refrigerant hole and extends toward the gas hole. The bearing refrigerant passage may extend through the bearing refrigerant pipe. The linear compressor may include a bearing insertion pipe that is inserted into the gas hole and contacts one side of the plenum flange that defines the bearing refrigerant hole. The bearing refrigerant passage may extend through the bearing refrigerant hole and the bearing insertion pipe. The discharge plenum may include a plenum guide surface that contacts an inner surface of the discharge cover. The bearing refrigerant passage may extend through the plenum guide surface. The plenum guide surface may extend into the gas hole. The discharge unit may include a discharge cover connected to the discharge frame surface, and a discharge plenum received in the discharge cover. The linear compressor may include a bearing refrigerant pipe extending through the discharge plenum and defining the bearing refrigerant passage. The bearing refrigerant pipe may have thermal conductivity less than the discharge plenum. The linear compressor may include a bearing insertion pipe that is inserted into the gas hole and defines at least a portion of the bearing refrigerant passage. The discharge unit may include a discharge cover connected to the discharge frame surface, and a discharge plenum received in the discharge cover and defining a bearing refrigerant hole that extends through the discharge plenum. The bearing insertion pipe may be disposed between the bearing refrigerant hole and the gas hole. The frame may include a gas passage that extends between the gas hole and the cylinder. A portion of the refrigerant that flows into the discharge space may pass through the bearing refrigerant passage, the gas hole, and the gas passage to flow into the cylinder.

Particular implementations of the present disclosure described herein provide a linear compressor that includes a piston, a cylinder, a frame, and a discharge unit. The piston may be configured to reciprocate in an axial direction. The cylinder may be configured to receive the piston. The frame may be configured to receive the cylinder. The discharge unit may define a discharge space configured to discharge a refrigerant that is compressed by the piston flows. The discharge unit may be connected to an axial side of the frame. The frame may include a discharge frame surface and a gas hole. The discharge frame surface may be connected to the discharge unit and define an axial surface. The gas hole may be defined at the discharge frame surface and extend in the axial direction. The discharge unit may include a bearing refrigerant passage that is defined at an axial side of the gas hole and configured to permit a portion of the refrigerant to flow from the discharge space to the gas hole.

In some implementations, the linear compressor described herein optionally include one or more of the following features. The bearing refrigerant passage may extend in the axial direction so that the portion of the refrigerant flows in the axial direction. The bearing refrigerant passage may extend in the axial direction and be configured to be at least partially disposed in the gas hole. The discharge unit may include a discharge cover and a discharge plenum. The discharge cover may be connected to the discharge frame surface. The discharge plenum may be received in the discharge cover and configured to divide the discharge space into a plurality of discharge chambers. The bearing refrigerant passage may extend through the discharge plenum. The plurality of discharge chambers may include a first discharge chamber configured to permit the refrigerant that is compressed by the piston to flow; a second discharge chamber disposed in an axial side of the first discharge chamber and configured to permit the refrigerant that passes through the first discharge chamber to flow; and a third discharge chamber disposed radially around the first and second discharge chambers and configured to permit the refrigerant that passes through the second discharge chamber to flow. The bearing refrigerant passage may be configured to permit a portion of the refrigerant that flows into the third discharge chamber to flow to the gas hole.

The discharge unit disclosed in this specification may include a discharge cover and a discharge plenum disposed inside the discharge cover. 1) First embodiment: an opening (a bearing refrigerant hole) may be defined in the discharge plenum to provide a bearing refrigerant passage. Alternatively, 2) second embodiment: the discharge plenum may extend toward the gas hole to provide a bearing refrigerant passage passing therethrough. Alternatively, 3) third embodiment: a pipe (a bearing refrigerant pipe) may be provided in an opening defined in the discharge plenum to provide a bearing refrigerant passage. Alternatively, 4) fourth embodiment: the gas hole and the opening defined in the discharge plenum may communicate with each other to provide a bearing refrigerant passage.

The linear compressor according to embodiments includes a cylinder providing a compression space for a refrigerant, a frame in which the cylinder is accommodated therein, and a discharge unit defining a discharge space for the refrigerant, in which the refrigerant discharged from the compression space flows.

The frame includes a discharge frame surface coupled to the discharge unit and a gas hole defined to be recessed from the discharge frame surface.

The discharge unit includes a bearing refrigerant passage extending toward the gas hole so that a portion of the refrigerant flowing into the discharge space flows into the gas hole.

The details of one or more embodiments are set forth in the accompanying drawings and the description below. Other features will be apparent from the description and drawings, and from the claims.

### BRIEF DESCRIPTION OF THE DRAWINGS

FIG. 1 is a view of a linear compressor according to a first embodiment.

FIG. 2 is an exploded view illustrating an internal configuration of the linear compressor according to the first embodiment.

FIG. 3 is a cross-sectional view taken along line III-III′ of FIG. 1.

FIG. 4 is a view illustrating a discharge unit and a frame of the linear compressor according to the first embodiment.

FIG. 5 is a view illustrating the discharge unit of the linear compressor according to the first embodiment.

FIG. 6 is an exploded view illustrating the discharge unit of the linear compressor according to the first embodiment.

FIG. 7 is a view illustrating a state in which a discharge cover of the linear compressor is cut according to the first embodiment.

FIG. 8 is a view illustrating a state in which a discharge plenum of the linear compressor is cut according to the first embodiment.

FIG. 9 is a view illustrating a portion ‘A’ of FIG. 3 together with a flow of the refrigerant.

FIG. 10 is a view illustrating the frame of the linear compressor together with the flow of the refrigerant according to the first embodiment.

FIG. 11 is a view illustrating a state in a discharge plenum of a linear compressor is cut according to a second embodiment.

FIG. 12 is a view illustrating a portion of the linear compressor together with a flow of a refrigerant according to the second embodiment.

FIG. 13 is a view illustrating a portion of a linear compressor together with a flow of a refrigerant according to a third embodiment.

FIG. 14 is a view illustrating a portion of a linear compressor together with a flow of a refrigerant according to a fourth embodiment.

### DETAILED DESCRIPTION OF THE EMBODIMENTS

Hereinafter, some embodiments of the present disclosure will be described in detail with reference to the accompanying drawings. Exemplary embodiments of the present disclosure will be described below in more detail with reference to the accompanying drawings. It is noted that the same or similar components in the drawings are designated by the same reference numerals as far as possible even if they are shown in different drawings. In the following description of the present disclosure, a detailed description of known functions and configurations incorporated herein will be omitted to avoid making the subject matter of the present disclosure unclear.

In the description of the elements of the present disclosure, the terms first, second, A, B, (a), and (b) may be used. Each of the terms is merely used to distinguish the corresponding component from other components, and does not delimit an essence, an order or a sequence of the corresponding component. It should be understood that when one component is “connected”, “coupled” or “joined” to another component, the former may be directly connected or jointed to the latter or may be “connected”, coupled” or “joined” to the latter with a third component interposed therebetween.

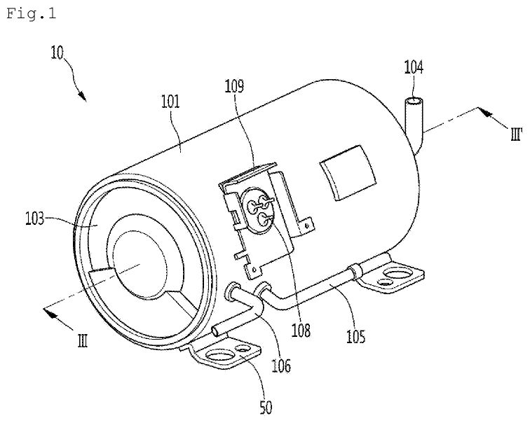

FIG. 1 is a view of a linear compressor according to a first embodiment.

Referring to FIG. 1, a linear compressor 10 according to an embodiment includes a shell 101 and shell covers 102 and 103 coupled to the shell 101. In a broad sense, each of the shell covers 102 and 103 may be understood as one component of the shell 101.

A leg 50 may be coupled to a lower portion of the shell 101. The leg 50 may be coupled to a base of a product in which the linear compressor 10 is installed. For example, the product may include a refrigerator, and the base may include a machine room base of the refrigerator. For another example, the product may include an outdoor unit of an air conditioner, and the base may include a base of the outdoor unit.

The shell 101 may have an approximately cylindrical shape and be disposed to lie in a horizontal direction or an axial direction. In FIG. 1, the shell 101 may extend in the horizontal direction and have a relatively low height in a radial direction. That is, since the linear compressor 10 has a low height, for example, when For example the linear compressor 10 is installed in the machine room base of the refrigerator, a machine room may be reduced in height.

Also, a longitudinal central axis of the shell 101 may correspond to a central axis of the compressor body, which will be described later. The central axis of the compressor body may correspond to a central axis of each of the cylinder and the piston, which constitute the compressor body.

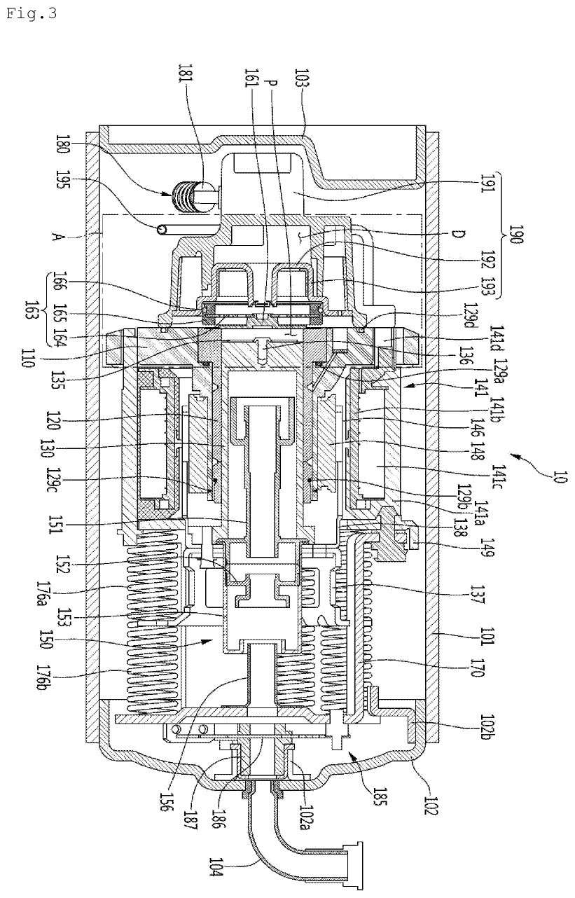

A terminal 108 may be installed on an outer surface of the shell 101. The terminal 108 may be understood as a component for transmitting external power to a motor assembly 140 (see FIG. 3) of the linear compressor 10. Particularly, the terminal 108 may be connected to a lead line of a coil 141 (see FIG. 3).

A bracket 109 is installed outside the terminal block 108. The bracket 109 may include a plurality of brackets surrounding the terminal 108. The bracket 109 may protect the terminal block 108 against an external impact and the like.

Both sides of the shell 101 may be opened. The shell covers 102 and 103 may be coupled to both opened sides of the shell 101. In detail, the shell covers 102 and 103 include a first shell cover 102 (see FIG. 3) coupled to one opened side of the shell 101 and a second shell cover 103 coupled to the other opened side of the shell 101. An inner space of the shell 101 may be sealed by the shell covers 102 and 103.

In FIG. 1, the first shell cover 102 may be disposed at a right portion of the linear compressor 10, and the second shell cover 103 may be disposed at a left portion of the linear compressor 10. That is to say, the first and second shell covers 102 and 103 may be disposed to face each other. Also, the first shell cover 102 may be disposed at a refrigerant suction-side, and the discharge shell cover 103 may be disposed at a refrigerant discharge-side.

The linear compressor 10 further includes a plurality of pipes 104, 105, and 106, which are provided in the shell 101 or the shell covers 102 and 103 to suction, discharge, or inject the refrigerant.

The plurality of pipes 104, 105, and 106 include a suction pipe 104 through which the refrigerant is suctioned into the linear compressor 10, a discharge pipe 105 through which the compressed refrigerant is discharged from the linear compressor 10, and a process pipe through which the refrigerant is supplemented to the linear compressor 10.

For example, the suction pipe 104 may be coupled to the first shell cover 102. The refrigerant may be suctioned into the linear compressor 10 through the suction pipe 104 in an axial direction.

The discharge pipe 105 may be coupled to an outer circumferential surface of the shell 101. The refrigerant suctioned through the suction pipe 104 may flow in the axial direction and then be compressed. Also, the compressed refrigerant may be discharged through the discharge pipe 105. The discharge pipe 105 may be disposed at a position that is closer to the second shell cover 103 than the first shell cover 102.

The process pipe 106 may be coupled to an outer circumferential surface of the shell 101. A worker may inject the refrigerant into the linear compressor 10 through the process pipe 106.

The process pipe 106 may be coupled to the shell 101 at a height different from that of the discharge pipe 105 to avoid interference with the discharge pipe 105. The height is understood as a distance from the leg 50 in the vertical direction. Since the discharge pipe 105 and the process pipe 106 are coupled to the outer circumferential surface of the shell 101 at the heights different from each other, work convenience may be improved.

At least a portion of the second shell cover 103 may be disposed adjacent to the inner circumferential surface of the shell 101, which corresponds to a point to which the process pipe 106 is coupled. That is to say, at least a portion of the second shell cover 103 may act as flow resistance of the refrigerant injected through the process pipe 106.

Thus, in view of a passage for the refrigerant, the passage for the refrigerant introduced through the process pipe 106 decreases in size by the second shell cover 103 when entering into the inner space of the shell 101 and then increases in size again after passing through the inner space of the shell 101. In this process, a pressure of the refrigerant may be reduced to allow the refrigerant to be vaporized. Also, in this process, an oil component contained in the refrigerant may be separated. Thus, the refrigerant from which the oil component is separated may be introduced into the piston 130 (see FIG. 3) to improve compression performance of the refrigerant. The oil component may be understood as working oil existing in a cooling system.

A device supporting the compressor body disposed inside the shell 101 may be provided inside the first and second shell covers 102 and 103. Here, the compressor body represents a component provided in the shell 101. For example, the compressor body may include a driving portion that reciprocates forward and backward and a support portion supporting the driving portion.

Hereinafter, the compressor body will be described in detail.

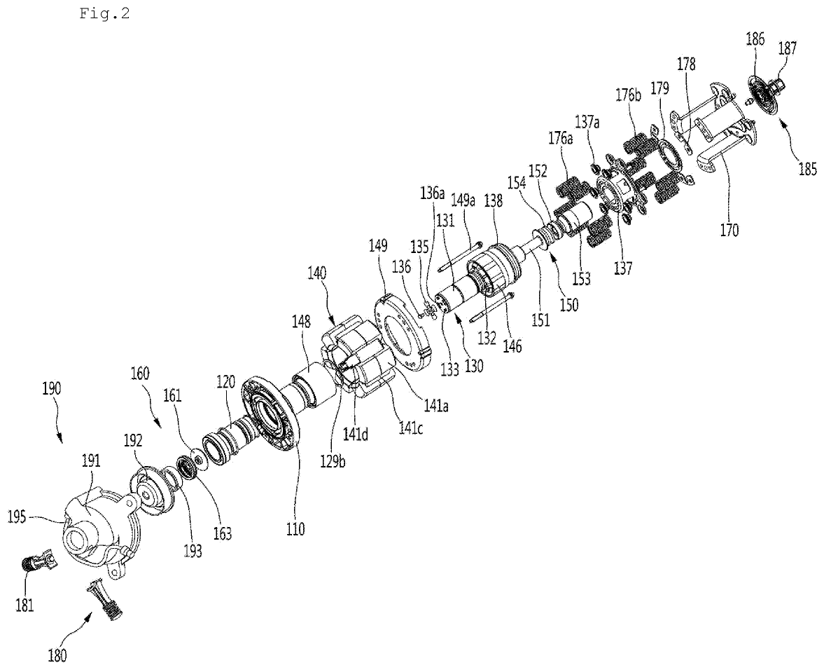

FIG. 2 is an exploded view illustrating an internal configuration of the linear compressor according to the first embodiment, and FIG. 3 is a cross-sectional view taken along line of FIG. 1.

Referring to FIGS. 2 and 3, the linear compressor 10 according to an embodiment includes a frame 110, a cylinder 120, a piston 130 that linearly reciprocates within the cylinder 120, and a motor assembly 140 that functions as a linear motor for applying driving force to the piston 130. When the motor assembly 140 is driven, the piston 130 may linearly reciprocate in the axial direction.

Hereinafter, the direction will be defined.

The “axial direction” may be understood as a direction in which the piston 130 reciprocates, i.e., the horizontal direction in FIG. 3. Also, in the axial direction”, a direction from the suction pipe 104 toward a compression space P, i.e., a direction in which the refrigerant flows may be defined as a “forward direction”, and a direction opposite to the front direction may be defined as a “backward direction”. When the piston 130 moves forward, the compression space P may be compressed.

On the other hand, the “radial direction” may be understood as a direction that is perpendicular to the direction in which the piston 130 reciprocates, i.e., the vertical direction in FIG. 3. Also, a direction that is away from the central axis of” the piston 130 may be defined as “the outside”, and a direction that is close to the central axis may be defined as “the inside”. The central axis of the piston 130 may correspond to the central axis of the shell 101 as described above.

The frame 110 is understood as a component for fixing the cylinder 120. The frame 110 is disposed to surround the cylinder 120. That is, the cylinder 120 may be disposed to be accommodated into the frame 110. For example, the cylinder 120 may be press-fitted into the frame 110. Also, each of the cylinder 120 and the frame 110 may be made of aluminum or an aluminum alloy material.

The cylinder 120 is configured to accommodate at least a portion of the piston 130. Also, the cylinder 120 has a compression space P in which the refrigerant is compressed by the piston 130.

Here, the compression space P may be understood as a space defined between the suction valve 135 and the discharge valve 161, which will be described later. Also, the suction valve 135 may be disposed on one side of the compression space P, and the discharge valve 161 may be disposed on the other side of the compression space P, i.e., an opposite side of the suction valve 135.

The piston 130 includes a piston body 131 having an approximately cylindrical shape and a piston flange 132 extending from the piston body 131 in the radial direction. The piston body 131 may reciprocate inside the cylinder 120, and the piston flange 132 may reciprocate outside the cylinder 120.

A suction hole 133 through which the refrigerant is introduced into the compression space P is defined in a front surface of the piston body 131, and a suction valve 135 for selectively opening the suction hole 133 is disposed on a front side of the suction hole 133.

Also, a coupling hole 136a to which a predetermined coupling member 136 is coupled is defined in a front surface of the piston body 131. In detail, the coupling hole 136a may be defined in a center of the front surface of the piston body 131, and a plurality of suction holes 133 are defined to surround the coupling hole 136a. Also, the coupling member 136 passes through the suction valve 135 and is coupled to the coupling hole 136a to fix the suction valve 135 to the front surface of the piston body 131.

The motor assembly 140 includes an outer stator 141 fixed to the frame 110 and disposed to surround the cylinder 120, an inner stator 148 disposed to be spaced inward from the outer stator 141, and a permanent magnet 146 disposed in a space between the outer stator 141 and the inner stator 148.

The permanent magnet 146 may linearly reciprocate by a mutual electromagnetic force between the outer stator 141 and the inner stator 148. Also, the permanent magnet 146 may be provided as a single magnet having one polarity or be provided by coupling a plurality of magnets having three polarities to each other.

The permanent magnet 146 may be disposed on the magnet frame 138. The magnet frame 138 may have an approximately cylindrical shape and be disposed to be inserted into the space between the outer stator 141 and the inner stator 148.

In detail, in FIG. 3, the magnet frame 138 may be coupled to the piston flange 132 to extend outward in the radial direction and then be bent forward. Here, the permanent magnet 146 may be installed on a front portion of the magnet frame 138. Thus, when the permanent magnet 146 reciprocates, the piston 130 may reciprocate together with the permanent magnet 146 in the axial direction by the magnet frame 138.

The outer stator 141 includes coil winding bodies 141b, 141c, and 141d and a stator core 141a. The coil winding bodies 141b, 141c, and 141d include a bobbin 141b and a coil 141c wound in a circumferential direction of the bobbin 141b.

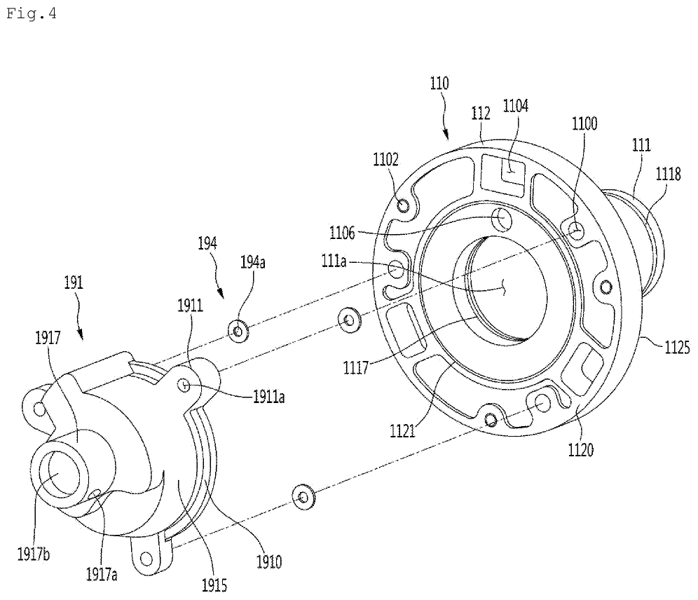

The coil winding bodies 141b, 141c, and 141d further include a terminal portion 141d that guides a power line connected to the coil 141c so that the power line is led out or exposed to the outside of the outer stator 141. The terminal portion 141d may be inserted into a terminal insertion hole 1104 (see FIG. 4) provided in the frame 110.

The stator core 141a includes a plurality of core blocks in which a plurality of laminations are laminated in a circumferential direction. The plurality of core blocks may be disposed to surround at least a portion of the coil winding bodies 141b and 141c.

A stator cover 149 may be disposed on one side of the outer stator 141. That is, the outer stator 141 may have one side supported by the frame 110 and the other side supported by the stator cover 149.

Also, the linear compressor 10 further includes a cover coupling member 149a for coupling the stator cover 149 to the frame 110. The cover coupling member 149a may pass through the stator cover 149 to extend forward to the frame 110 and then be coupled to a stator coupling hole 1102 (see FIG. 4) of the frame 110.

The inner stator 148 is fixed to an outer circumference of the frame 110. Also, in the inner stator 148, the plurality of laminations are laminated outside the frame 110 in the circumferential direction.

Also, the linear compressor 10 further include a suction muffler 150 coupled to the piston 130 to reduce a noise generated from the refrigerant suctioned through the suction pipe 104. The refrigerant suctioned through the suction pipe 104 flows into the piston 130 via the suction muffler 150. For example, while the refrigerant passes through the suction muffler 150, the flow noise of the refrigerant may be reduced.

The suction muffler 150 includes a plurality of mufflers 151, 152, and 153. The plurality of mufflers 151, 152, and 153 include a first muffler 151, a second muffler 152, and a third muffler 153, which are coupled to each other.

The first muffler 151 is disposed within the piston 130, and the second muffler 152 is coupled to a rear side of the first muffler 151. Also, the third muffler 153 accommodates the second muffler 152 therein and extends to a rear side of the first muffler 151. In view of a flow direction of the refrigerant, the refrigerant suctioned through the suction pipe 104 may successively pass through the third muffler 153, the second muffler 152, and the first muffler 151. In this process, the flow noise of the refrigerant may be reduced.

Also, the suction muffler 150 further includes a muffler filter 154. The muffler filter 154 may be disposed on an interface on which the first muffler 151 and the second muffler 152 are coupled to each other. For example, the muffler filter 154 may have a circular shape, and an outer circumferential portion of the muffler filter 154 may be supported between the first and second mufflers 151 and 152.

Also, the linear compressor 10 further includes a supporter 137 for supporting the piston 130. The supporter 137 may be coupled to a rear portion of the piston 130, and the muffler 150 may be disposed to pass through the inside of the supporter 137. Also, the piston flange 132, the magnet frame 138, and the supporter 137 may be coupled to each other by using a coupling member.

A balance weight 179 may be coupled to the supporter 137. A weight of the balance weight 179 may be determined based on a driving frequency range of the compressor body. Also, the supporter 137 may include a first spring support portion 137a coupled to the first resonant spring 176a that will be described later.

Also, the linear compressor 10 further include a rear cover 170 coupled to the stator cover 149 to extend backward. The rear cover 170 includes three support legs, and the three support legs may be coupled to a rear surface of the stator cover 149.

Also, a spacer 178 may be disposed between the three support legs and the rear surface of the stator cover 149. A distance from the stator cover 149 to a rear end of the rear cover 170 may be determined by adjusting a thickness of the spacer 178. Also, the rear cover 170 may be spring-supported by the supporter 137.

Also, the linear compressor 10 further includes an inflow guide portion 156 coupled to the rear cover 170 to guide an inflow of the refrigerant into the muffler 150. At least a portion of the inflow guide portion 156 may be inserted into the suction muffler 150.

Also, the linear compressor 10 further includes a plurality of resonant springs 176a and 176b that are adjusted in natural frequency to allow the piston 130 to perform a resonant motion. The plurality of resonant springs 176a and 176b include a first resonant spring 176a supported between the supporter 137 and the stator cover 149 and a second resonant spring 176b supported between the supporter 137 and the rear cover 170.

The driving portion that reciprocates within the linear compressor 10 may stably move by the action of the plurality of resonant springs 176a and 176b to reduce the vibration or noise due to the movement of the driving portion.

Also, the linear compressor 10 includes a discharge unit 190 and a discharge valve assembly 160.

The discharge unit 190 defines a discharge space D of the refrigerant discharged from the compression space P. The discharge unit 190 includes a discharge cover 191 coupled to the front surface of the frame 110 and a discharge plenum 192 disposed inside the discharge cover 191. Also, the discharge unit 190 may further include a cylindrical fixing ring 193 that is in close contact with an inner circumferential surface of the discharge plenum 192.

The discharge valve assembly 160 is coupled to the inside of the discharge unit 190 and discharges the refrigerant compressed in the compression space P to the discharge space D. Also, the discharge valve assembly 160 may include a discharge valve 161 and a spring assembly 163 providing elastic force in a direction in which the discharge valve 161 contacts the front end of the cylinder 120.

The spring assembly 163 may include a valve spring 164 having a plate spring shape, a spring support portion 165 disposed on an edge of the valve spring 164 to support the valve spring 164, and a friction ring 166 inserted into an outer circumferential surface of the spring support portion 165.

A central portion of a front surface of the discharge valve 161 is fixed and coupled to a center of the valve spring 164. Also, a rear surface of the discharge valve 161 contacts the front surface (a front end) of the cylinder 120 by elastic force of the valve spring 164.

When a pressure in the compression space P is equal to or greater than the discharge pressure, the valve spring 164 is elastically deformed toward the discharge plenum 192. Also, the discharge valve 161 is spaced apart from a front end of the cylinder 120 so that the refrigerant is discharged into the discharge space D (or the discharge chamber) defined in the discharge plenum 192 in the compression space P.

That is, when the discharge valve 161 is supported on the front surface of the cylinder 120, the compression space may be maintained in the sealed state. When the discharge valve 161 is spaced apart from the front surface of the cylinder 120, the compression space P may be opened to allow the refrigerant in the compression space P to be discharged.

Also, the linear compressor 10 may further include a cover pipe 195. The cover pipe 195 discharges the refrigerant flowing into the discharge unit 190 to the outside. Here, the cover pipe 195 has one end coupled to the discharge cover 191 and the other end coupled to the discharge pipe 105. Also, at least a portion of the cover pipe 195 may be made of a flexible material and roundly extend along the inner circumferential surface of the shell 101.

Also, the linear compressor 10 includes the frame 110 and a plurality of sealing members for increasing coupling force between the peripheral components around the frame 110. Each of the plurality of sealing members may have a ring shape.

In detail, the plurality of sealing members include first and second sealing members 129a and 129b disposed on portions at which the frame 110 and the cylinder 120 are coupled to each other. Here, the first sealing member 129a is installed to be inserted into the frame 110, and the second sealing member 129b is installed to be inserted into the cylinder 120.

In detail, the plurality of sealing members include a first sealing member 127 disposed on a portion at which the frame 110 and the inner stator 148 are coupled to each other. The third sealing member 129c may be installed to be inserted into an outer surface of the frame 110.

Also, the plurality of sealing members may include a fourth sealing member 129d disposed on a portion at which the frame 110 and the discharge cover 191 are coupled to each other. The fourth sealing member 129d may be installed to be inserted into the front surface of the frame 110.

Also, the linear compressor 10 includes support devices 180 and 185 for fixing the compressor body to the inside of the shell 101. The support device includes a first support device 185 disposed at the suction-side of the compressor body and a second support device 180 disposed at the discharge-side of the compressor body.

The first support device 185 includes a suction spring 186 provided in a circular plate spring shape and a suction spring support portion 187 fitted into a center of the suction spring 186.

An outer edge of the suction spring 186 may be fixed to a rear surface of the rear cover 170 by a coupling member. The suction spring support portion 187 is coupled to the cover support portion 102a disposed at a center of the first shell cover 102. Thus, the rear end of the compressor body may be elastically supported at the central portion of the first shell cover 102.

Also, a suction stopper 102b may be disposed on an inner edge of the first shell cover 102. The suction stopper 102b may be understood as a component for preventing the compressor body, particularly, the motor assembly 140 from being bumped by the shell 101 and thus damaged due to the shaking, the vibration, or the impact occurring during the transportation of the linear compressor 10.

Particularly, the suction stopper 102b may be disposed adjacent to the rear cover 170. Thus, when the linear compressor 10 is shaken, the rear cover 170 may interfere with the suction stopper 102b to prevent the impact from being directly transmitted to the motor assembly 140.

The second support device 180 includes a pair of discharge support portions 181 extending in the radial direction. The discharge support portion 181 has one end fixed to the discharge cover 191 and the other end contacting an inner circumferential surface of the shell 101. Thus, the discharge support portion 181 may support the compressor body in a radial direction.

For example, the pair of discharge support portion 181 are disposed at an angle of about 90 degrees to about 120 degrees with respect to each other in the circumferential direction with respect to the lower end that is closest to the bottom surface. That is, the lower portion of the compressor body may be supported at two points.

Also, the second support device 180 may include a discharge sparing (not shown) installed in the axial direction. For example, the discharge spring (not shown) may be disposed between an upper end of the discharge cover 191 and the second shell cover 103.

A process of compressing the refrigerant will be described based on this configuration. As the linear compressor 10 is driven, the piston 130 reciprocates in the axial direction inside the cylinder 120. That is, power is applied to the motor assembly 140, and the piston 130 may move together with the permanent magnet 146.

Thus, the refrigerant is suctioned into the shell 101 through the suction pipe 104. Then, the suction refrigerant flows through the muffler 150 to flow into the piston 130.

Here, when a pressure within the compression space P is less than or equal to the suction pressure of the refrigerant, the suction valve 135 is deformed to open the compression space P. Thus, the suction refrigerant accommodated into the piston 130 may flow into the compression space P.

Also, when the pressure within the compression space P is greater than or equal to the suction pressure of the refrigerant, the compression space P is closed by the suction valve 135. Thus, the refrigerant accommodated in the compression space P may be compressed by forward movement of the piston 130.

When the pressure within the compression space P is greater than or equal to the pressure within the discharge space D, the valve spring 164 is deformed forward to separate the discharge valve 161 from the cylinder 120. That is, the compression space P is opened by the discharge valve 161. Also, the refrigerant compressed in the compression space P flows into the discharge space S through the spaced space between the discharge valve 161 and the cylinder 120.

Also, when the pressure within the compression space P is less than or equal to the pressure within the discharge space D, the valve spring 164 provides restoring force to the discharge valve 161, and thus, the discharge valve 161 is in close contact with the front end of the cylinder 120 again. That is, the compression space P is closed by the discharge valve 161.

The refrigerant flowing into the discharge space D sequentially passes through the cover pipe 195 and the discharge pipe 105 and then is discharged to the outside of the shell 101. Also, the refrigerant discharged from the linear compressor 10 may be suctioned again into the linear compressor 10 by passing through a predetermined device to circulate.

Here, the compression space P and the discharge space D may be provided to communicate with each other by the coupling of the discharge unit 190 and the frame 110. Hereinafter, the discharge unit 190 and the frame 110 will be described in detail.

FIG. 4 is a view illustrating the discharge unit and the frame of the linear compressor according to the first embodiment.

As illustrated in FIG. 4, the discharge cover 191 and the frame 110 may be coupled to each other through a predetermined coupling member (not shown). Particularly, the discharge cover 191 and the frame 110 may be coupled to each other at three points.

The frame 110 includes a frame body 111 extending in the axial direction and a frame flange 112 extending outward from the frame body 111 in the radial direction. Here, the frame body 111 and the frame flange 112 may be integrated with each other.

The frame body 111 has a cylindrical shape of which upper and lower ends in the axial direction are opened. Also, a cylinder accommodation portion 111a into which the cylinder 120 is accommodated is provided in the frame body 111. Thus, the cylinder 120 is accommodated in the frame body 111 in the radial direction, and at least a portion of the piston 130 is accommodated in the cylinder 120 in the radial direction.

Also, sealing member insertion portions 1117 and 1118 are provided in the frame body 111. The sealing member insertion portions 1117 and 1118 include a first sealing member insertion portion 1117 which is provided inside the frame body 111 and into which a first sealing member 129a is inserted. Also, the sealing member insertion portions include a third sealing member insertion portion 1118 which is provided on an outer circumferential surface of the frame body 111 and into which a third sealing member 129a is inserted.

Also, an inner stator 148 is coupled to the outside of the frame body 111 in the radial direction. The outer stator 141 is disposed outward the inner stator 148 in the radial direction, and a permanent magnet 146 is disposed between the inner stator 148 and an outer stator 141.

The frame flange 112 have a circular plate shape having a predetermined thickness in the axial direction. In detail, the frame flange 112 is provided in a ring shape having a predetermined thickness in the axial direction due to the cylinder accommodating portion 111a provided at a central side in the radial direction.

Particularly, the frame flange 112 extends from a front end of the frame body 111 in the radial direction. Thus, the inner stator 148, the permanent magnet 146, and the outer stator 141, which are disposed outside the frame body 111 in the radial direction, may be disposed at a rear side of the frame flange 112 in the axial direction.

Also, a plurality of openings passing in the axial direction are defined in the frame flange 112. Here, the plurality of openings include a discharge coupling hole 1100, a stator coupling hole 1102, and a terminal insertion hole 1104.

A predetermined coupling member (not shown) for coupling the discharge cover 191 to the frame 110 is inserted into the discharge coupling hole 1100. In detail, the coupling member (not shown) may be inserted to a front side of the frame flange 112 by passing through the discharge cover 191.

The above-described cover coupling member 149a that is described above is inserted into the stator coupling hole 1102. The cover coupling member 149a may couple the stator cover 149 to the frame flange 112 to fix the outer stator 114 disposed between the stator cover 149 and the frame flange 112 in the axial direction.

The above-described terminal portion 141d of the outer stator 141 may be inserted into the terminal insertion portion 1104. That is, the terminal portion 141d may be withdrawn or exposed to the outside through the terminal insertion hole 1104 by passing from the rear side to the front side of the frame 110.

Here, each of the discharge coupling hole 1100, the stator coupling hole 1102, and the terminal insertion hole 1104 may be provided in plurality, which are sequentially disposed spaced apart from each other in the circumferential direction. For example, each of the discharge coupling hole 1100, the stator coupling hole 1102, and the terminal insertion hole 1104 may be provided in three, which are sequentially disposed at an angle of about 120 degrees in the circumferential direction.

Also, the terminal insertion holes 1104, the discharge coupling holes 1100, and the stator coupling holes 1102 are sequentially disposed to be spaced apart from each other in the circumferential direction. Also, the openings adjacent to each other may be disposed to be spaced an angle of about 30 degrees from each other in the circumferential direction.

For example, the respective terminal insertion holes 1104 and the respective discharge coupling holes 1100 are disposed spaced an angle of about 30 degrees from each other in the circumferential direction. Also, the respective discharge coupling holes 1100 and the respective stator coupling holes 1102 are disposed to be spaced an angle of about 30 degrees from each other in the circumferential direction. For example, the respective terminal insertion holes 1104 and the respective stator coupling holes 1102 are disposed spaced an angle of about 60 degrees from each other in the circumferential direction.

Also, the terminal insertion holes 1104, the discharge coupling holes 1100, and the stator coupling holes 1102 are arranged based on a center of the circumferential direction.

Here, a front surface of the frame flange 112 is referred to as a discharge frame surface 1120, and a rear surface thereof is referred to as a motor frame surface 1125. That is, the discharge frame surface 1120 and the motor frame surface 1125 correspond to surfaces opposite to each other in the axial direction. In detail, the discharge frame surface 1120 corresponds to a surface contacting the discharge cover 191. Also, the motor frame surface 1125 corresponds to a surface contacting the outer stator 141.

A fourth sealing member insertion portion 1121 into which the fourth sealing member 129c is inserted is provided on the discharge frame surface 1120. In detail, the fourth sealing member insertion portion 1121 has a ring shape and is recessed backward from the discharge frame surface 1120 in the axial direction.

Also, the fourth sealing member 129d is provided in a ring shape having a diameter corresponding to that of the fourth sealing member insertion portion 1121. The fourth sealing member 129d may prevent the refrigerant from leaking between the discharge cover 191 and the frame 110.

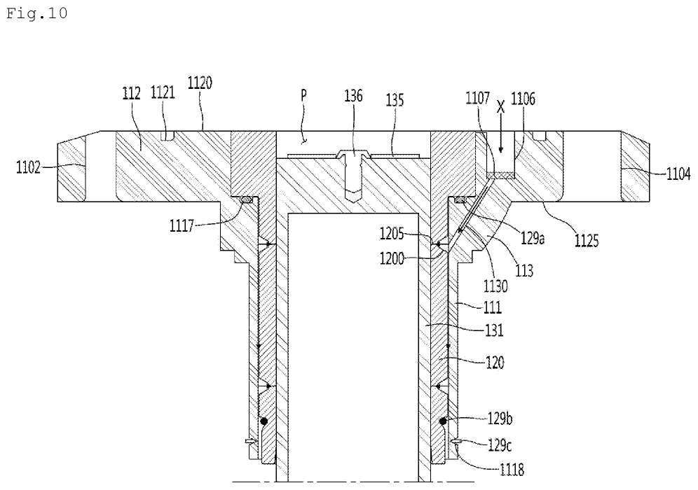

Also, a gas hole 1106 communicating with a gas passage 1130 to be described later is defined in the discharge frame surface 1120. The gas hole 1106 is recessed backward from the discharge frame surface 1120 in the axial direction. Also, a gas filter 1107 (see FIG. 10) for filtering foreign substances contained in the flowing gas may be mounted on the gas hole 1106.

Here, the gas hole 1106 is defined inside the fourth sealing member insertion portion 1121 in the radial direction. Also, the terminal insertion hole 1104, the discharge coupling hole 1100, and the stator coupling hole 1102 are defined outside the fourth sealing member insertion portion 1121 in the radial direction.

Also, referring to FIG. 4, a predetermined recess structure may be provided in the discharge frame surface 1120. This is done for preventing heat of the discharge refrigerant from being transferred, and the recess structure is not limited in recessed depth and shape.

As described above, the discharge unit 190 includes a discharge cover 191, a discharge plenum 192, and a fixing ring 193. Hereinafter, an outer appearance of the discharge cover 191 coupled to the frame 110 will be described. The outer appearance of the discharge cover 191, the discharge plenum 192, and the fixing ring 193 will be described in detail.

The outer appearance of the discharge cover 191 may have a bowl shape as a whole. In detail, the discharge cover may have a shape which has one opened surface and an inner space. Particularly, an axial rear side of the discharge cover 191 may be opened. Here, the discharge plenum 192 is disposed in the inner space.

The discharge cover 191 includes a cover flange portion 1910 coupled to the frame 110, a chamber portion 1915 extending forward from the cover flange portion 1910 in the axial direction, and a support device fixing portion 1917 extending forward from the chamber portion 1915 in the axial direction.

The cover flange portion 1910 contact the front surface of the frame 110. In detail, the cover flange portion 1910 is disposed to contact the discharge frame surface 1120.

Also, the cover flange portion 1910 has a predetermined thickness in the axial direction and extends in the radial direction. Thus, the cover flange portion 1910 may be provided in a circular plate shape as a whole.

Particularly, the cover flange portion 1910 may have a diameter corresponding to the fourth sealing member installation portion 1121. In detail, the diameter of the cover flange portion 1910 is slightly greater than that of the fourth sealing member installation portion 1121.

Here, the cover flange portion 1910 is relatively small in comparison with a diameter of the discharge frame surface 1120. For example, the diameter of the cover flange portion 1910 may be about 0.6 times to about 0.8 times of the diameter of the discharge frame surface 1120. In the linear compressor according to the related art, the diameter of the cover flange portion is set to about 0.9 times or more of the diameter of the discharge frame surface.

The above-described structure is for minimizing the heat transferred from the cover flange portion 1910 to the frame 110. In detail, the heat of the discharge cover 191 may be conducted to the frame 110 through the cover flange portion 1910 as the cover flange portion 1910 is disposed to contact the discharge frame surface 1120.

Here, since the thermal conductivity is proportional to the contact area, an amount of heat conducted according to the contact area between the cover flange portion 1910 and the discharge frame surface 1120 may be changed. That is, the diameter of the cover flange portion 1910 may be minimized to minimize the contact area with the discharge frame surface 1120. Thus, the amount of heat transferred to the frame 110 from the discharge cover 191 may be minimized.

As the contact area with the cover flange portion 1910 is reduced, a relatively large portion of the discharge frame surface 1120 may be exposed to the inside of the shell 101.

As described above, the surface exposed to the inside of the shell 101 contacts the refrigerant (hereinafter, referred to as a shell refrigerant) accommodated in the shell 101, and thus, heat transfer occurs. Particularly, since the shell refrigerant is provided at a temperature similar to that of the suction refrigerant, convention heat transfer is generated in the frame 110 from the shell refrigerant. Also, since the convection heat transfer is proportional to the contact area, the surface exposed to the inside of the shell 101 increases, an amount of heat to be dissipated may increase.

In summary, as the surface area of the cover flange portion 1910 decreases, the heat conducted to the frame 110 through the discharge cover 191 may decrease. Also, the heat dissipation from the frame 110 to the shell refrigerant may be effectively generated.

Thus, the frame 110 may be maintained at a relatively low temperature. Also, the heat transferred to the cylinder 120 and the piston 130 disposed inside the frame 110 is reduced. As a result, the temperature of the suction refrigerant is prevented from rising, and the compression efficiency is improved.

An opening communicating with an opened axial rear side is defined in a central portion of the cover flange portion 1910. The discharge plenum 192 may be mounted inside the discharge cover 191 the opening. Also, the opening may be understood as an opening in which the discharge valve assembly 160 is installed.

Also, the cover flange portion 1910 includes a flange coupling hole 1911a through which a coupling member (not shown) to be coupled to the frame 110 passes. The flange coupling holes 1911a passes in the axial direction and is provided in plurality.

The flange coupling hole 1911a may have a size, a number, and a position corresponding to those of a discharge coupling hole 1100. The flange coupling holes 1911a may be provided in three positions spaced an angle of about 120 degrees from each other in the circumferential direction.

The discharge cover 191 includes a cover coupling portion 1911 protruding from the cover flange portion 1910 in the radial direction to define the flange coupling hole 1911a. That is, the flange coupling hole 1911a is disposed outward from the cover flange portion 1910a in the radial direction. The discharge coupling hole 1100 may be disposed outward from the cover flange portion 1910a in the radial direction.

The cover coupling portion 1911 may be provided at three positions spaced an angle of about 120 degrees from each other in the circumferential direction corresponding to the flange coupling hole 1911a. Also, an edge of the cover coupling portion 1911 may have a thickness greater than that of the cover flange portion 1910 in the axial direction. It may be understood that the flange coupling hole 1911a is a portion to be coupled by the coupling member and is prevented from being damaged because relatively large external force is applied.

Each of the chamber portion 1915 and the support device fixing portion 1917 may have a cylindrical outer appearance. In detail, each of the chamber portion 1915 and the support device fixing portion 1917 has a predetermined outer diameter in the radial direction and extends in the axial direction. The outer diameter of the support device fixing portion 1917 is less than the outer diameter of the chamber portion 1915.

Also, the outer diameter of the chamber portion 1915 is less than the outer diameter of the cover flange portion 1910. That is, the discharge cover 191 may be stepped so that the outer diameter gradually decreases in the axial direction.

Also, the chamber portion 1915 and the support device fixing portion 1917 are provided in a shape of which an axial rear side is opened. Thus, each of the chamber portion 1915 and the support device fixing portion 1917 may have an outer appearance defined by a cylindrical side surface and a cylindrical front surface.

The chamber portion 1915 may further include a pipe coupling portion (not shown) to which the cover pipe 195 is coupled. Particularly, the cover pipe 195 may be coupled to the chamber portion 1915 to communicate with one of the plurality of discharge spaces D. The cover pipe 195 may communicate with the discharge space D through which the refrigerant finally passes.

At least a portion of a top surface of the chamber portion 1915 may be recessed to avoid interference with the cover pipe 195. When the cover pipe 195 is coupled to the chamber portion 1915, the cover pipe 195 may be prevented from contacting the front surface of the chamber portion 1915.

Fixed coupling portions 1917a and 1917b to which the above-described second support device 180 is coupled are disposed on the support device fixing portion 1917. The fixed coupling portion includes a first fixed coupling portion 1917a to which the discharge support portion 181 is coupled and a second fixed coupling portion 1917b to which a discharge spring (not shown) is installed.

The first fixed coupling portion 1917a may be recessed inward or penetrated from the outer surface of the support device fixing portion 1917 in the radial direction. The first fixed coupling portion 1917a is provided in a pair. The pair of first fixed coupling portions 1917a are spaced apart from each other in the circumferential direction to correspond to the pair of discharge support portions 181.

The second fixing portion 1917b may be recessed backward from the front surface of the support device fixing portion 1917 in the axial direction. Thus, at least a portion of the discharge spring (not shown) may be inserted into the second fixed coupling portion 1917b.

Here, the discharge cover 191 according to an embodiment may be integrally manufactured by aluminum die casting. Thus, unlike the discharge cover according to the related art, in the case of the discharge cover 191 according to an embodiment, a welding process may be omitted. Thus, the process of manufacturing the discharge cover 191 may be simplified, resulting in minimizing product defects, and the product cost may be reduced. Also, since there is no dimensional tolerance due to the welding, the refrigerant may be prevented from leaking.

The cover flange portion 1910, the chamber portion 1915, and the support device fixing portion 1917, which are described above, are integrated with each other and may be understood as being divided for convenience of explanation.

Also, the linear compressor 10 includes a gasket 194 disposed between the frame 110 and the discharge cover 191. In detail, the gasket 194 is disposed between the cover coupling portion 1911 and the discharge frame surface 1120.

Particularly, the gasket 194 may be disposed on a portion at which the frame 110 and the discharge cover 191 are coupled to each other. That is, it is understood that the gasket 194 is configured to more tightly couple the frame 110 to the discharge cover 191.

The gasket 194 may be provided in plurality. Particularly, a plurality of gaskets 194 are provided at positions and in numbers corresponding to the flange coupling holes 1911a and the discharge coupling holes 1100. That is, the plurality of gaskets 194 may be provided in three that are spaced an angle about 120 degrees from each other in the circumferential direction.

Also, the gasket 194 is provided in the form of a ring having a gasket through-hole 194a defined in a center thereof. The gasket through-hole 194a may have a size corresponding to the flange coupling hole 1911a and the discharge coupling hole 1100.

Also, an outer diameter of the gasket 194 may be less than that of the outer side of the cover coupling portion 1911. Thus, when the gasket through-hole 194 is aligned with the flange coupling hole 1911a, the gasket 194 may be disposed inside the cover coupling portion 1911.

The discharge cover 191, the gasket 194, and the frame 110 are laminated so that the flange coupling hole 1911a, the gasket through-hole 194a, and the discharge coupling hole 1100 are sequentially arranged in the downward direction. Also, since a coupling member passes through the flange coupling hole 1911a, the gasket through-hole 194a, and the discharge coupling hole 1100, the discharge cover 191, the gasket 194, and the frame 110 may be coupled to each other.

Hereinafter, the inner appearance of the discharge cover 191, the discharge plenum 192 and the fixing ring 193 will be described in detail.

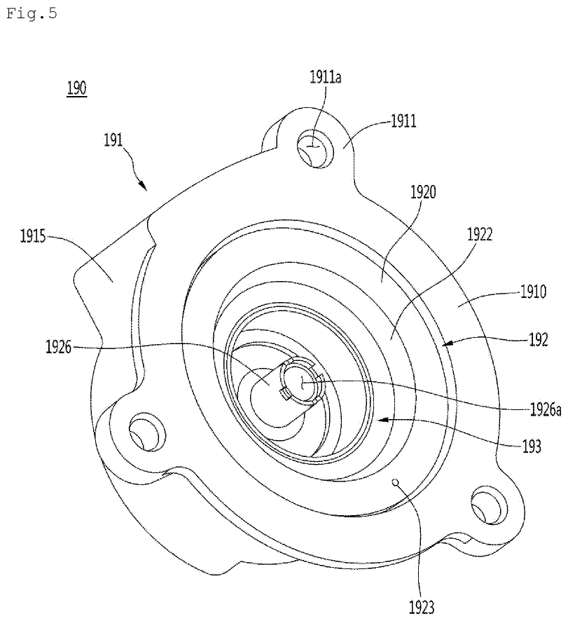

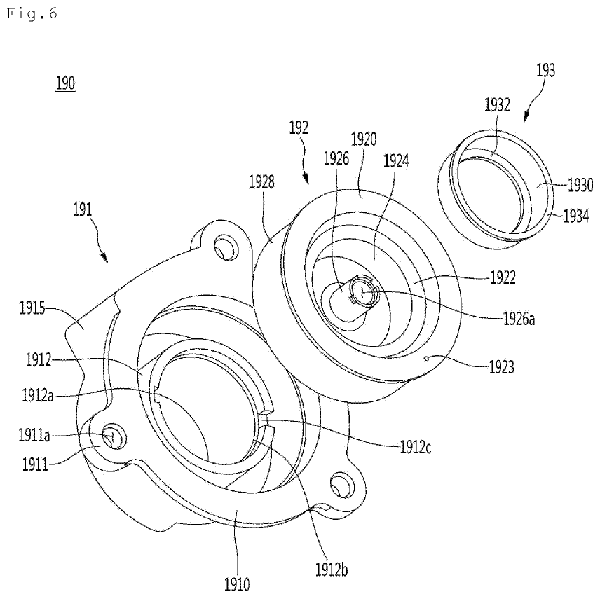

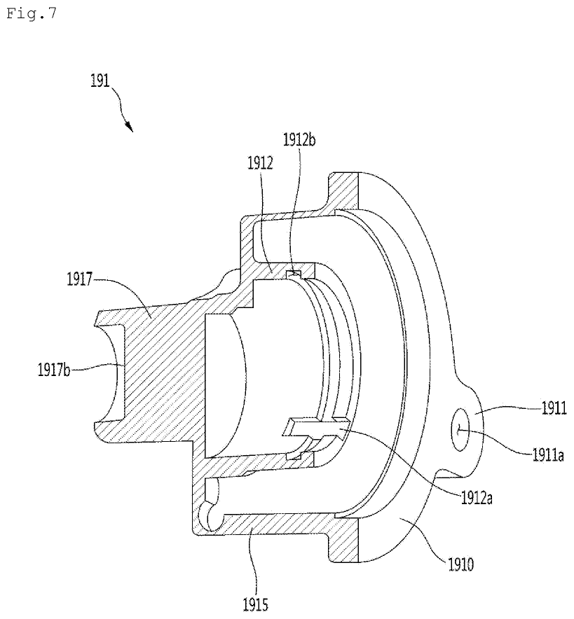

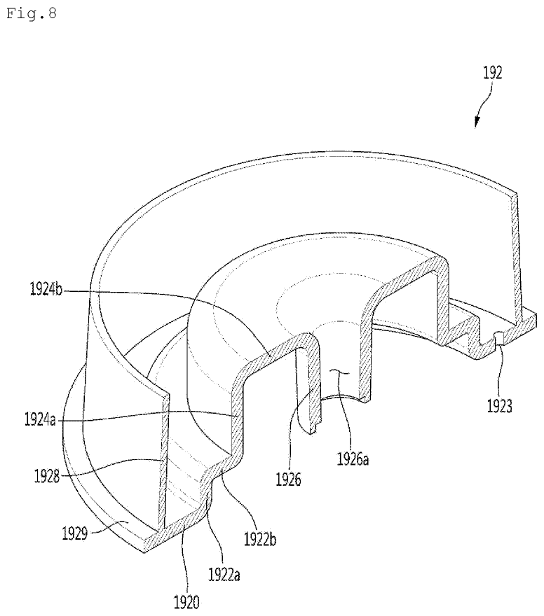

FIG. 5 is a view illustrating the discharge unit of the linear compressor according to the first embodiment, and FIG. 6 is an exploded view illustrating the discharge unit of the linear compressor according to the first embodiment. Also, FIG. 7 is a view illustrating a state in which the discharge cover of the linear compressor is cut according to the first embodiment, and FIG. 8 is a view illustrating a state in which the discharge plenum of the linear compressor is cut according to the first embodiment.

For ease of understanding, FIGS. 5 and 6 illustrate an axial rear side of the discharge unit 190. In addition, FIGS. 7 and 8 illustrate a state in which the discharge cover 191 and the discharge plenum 192 are cut in the axial direction in addition to a cross section.

As illustrated in FIGS. 5 and 6, the discharge unit 190 includes a discharge cover 191, a discharge plenum 192, and a fixing ring 193. Here, the discharge cover 191, the discharge plenum 192, and the fixing ring 193 may be manufactured through different materials and methods.

The discharge plenum 192 is coupled to the inside of the discharge cover 191, and the fixing ring 193 is coupled to the inside of the discharge plenum 192. Particularly, the discharge cover 191 and the discharge plenum 192 may be coupled to each other to define the plurality of discharge spaces D. The discharge space D may be understood as a space through which the refrigerant discharged from the compression space P flows.

An inner appearance of the discharge cover 191 will be described with reference to FIGS. 6 and 7. As described above, the discharge cover 191 may have a shape which has one opened surface and an inner space. In particular, the inner space may be defined inside the cover flange portion 1910 and the chamber portion 1915.

Also, the inner space may be divided into an upper space defined in an upper side of the plenum flange 1920 of the discharge plenum to be described later in the axial direction and a lower space defined in a lower side in the axial direction. Here, the upper space may correspond to the discharge space D.

Also, it may be understood that the upper space, that is, the discharge space D is defined inside the chamber portion 1915, and the lower space is defined inside the cover flange portion 1910.

The lower space corresponds to a space in which the discharge valve assembly 160 is installed. The frame 110 is disposed at a lower end of the lower space. In detail, the lower space is defined above the discharge frame surface 1120.

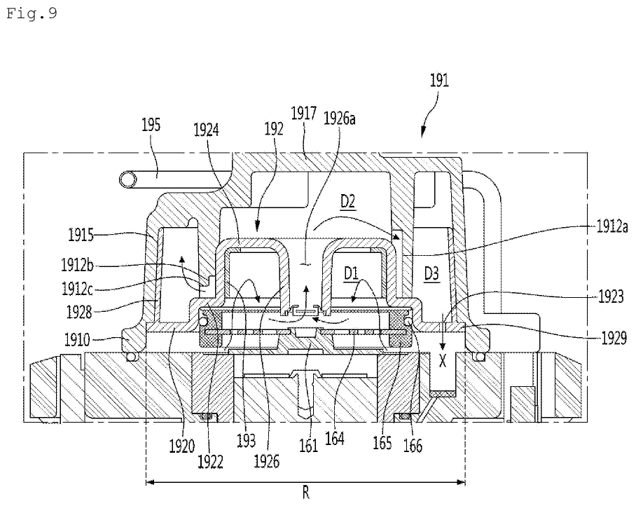

Also, each of the upper space and the lower space may be defined in a cylindrical shape extending in the axial direction. Here, a radial diameter of the space defined by the upper space and the lower space is referred to as an inner diameter R (see FIG. 9) of the discharge cover 191. Also, the inside of the discharge cover 191 may be provided to be stepped so as to fix the discharge plenum 192.

Also, the discharge cover 191 includes a partition sleeve 1912 that partitions the upper space. The partition sleeve 1912 may have a cylindrical shape extending from the inside of the upper space in the axial direction. Particularly, the partition sleeve 1912 may extend backward from the from surface of the chamber portion 1915 in the axial direction.

Also, an outer diameter of the partition sleeve 1912 is less than the inner diameter R of the discharge cover 191. In detail, the partition sleeve 1912 is spaced apart from an inner surface of the discharge cover 191 in the radial direction so that a predetermined space is defined between the partition sleeve 1912 and the inner surface of the discharge cover 191.

Thus, the inner space may be divided into the inside and the outside in the radial direction by the partition sleeve 1912. Here, a first discharge chamber D1 and a second discharge chamber D2 are provided inside the partition sleeve 1912 in the radial direction. Also, a third discharge chamber D3 is provided outside the partition sleeve 1912 in the radial direction.

Also, the discharge plenum 192 may be inserted into the partition sleeve 1912. In detail, at least a portion of the discharge plenum 192 may contact the inner surface of the partition sleeve 1912 and be inserted into the partition sleeve 1912.

Also, the partition sleeve 1912 may have a first guide groove 1912a, a second guide groove 1912b, and a third guide groove 1912c.

The first guide groove 1912a may be recessed outward from an inner surface of the partition sleeve 1912 in the radial direction and may extend in the axial direction. Particularly, the first guide groove 1912a extends backward from the axial front side rather than the position at which the discharge plenum 192 is inserted.

The second guide groove 1912b may be recessed outward from the inner surface of the partition sleeve 1912 in the radial direction and extend in the circumferential direction. Particularly, the second guide groove 1912b is defined in the inner surface of the partition sleeve 1912, which contacts the discharge plenum 192. Also, the second guide groove 1912b may communicate with the first guide groove 1912a.

The third guide groove 1912c may be recessed forward from an axial rear end of the partition sleeve 1912. Thus, the rear end of the partition sleeve 1912 may be stepped. Also, the third guide groove 1912c may communicate with the second guide groove 1912b.

That is, the third guide groove 1912c may be recessed up to a portion in which the second guide groove 1912b is defined. Also, the third guide groove 1912c and the first guide groove 1912a may be spaced apart from each other in the circumferential direction. For example, the third guide groove 1912c may be defined in a position facing the first guide groove 1912a, i.e., in a position spaced at an angle of about 180 degrees in the circumferential direction.

A time taken for the refrigerant flowing into the second guide groove 1912b to stay in the second guide groove 1912b may increase. Thus, pulsation noise of the refrigerant may be effectively reduced.

Hereinafter, the discharge plenum 192 will be descried in detail with reference to FIGS. 6 and 8.

The discharge plenum 192 includes a plenum flange 1920, a plenum seating portion 1922, a plenum body 1924, a plenum extension portion 1928, and a plenum guide surface 1928. Here, the discharge plenum 192 may be integrally made of engineering plastic. That is, each of the constituents of the discharge plenum 192 to be described later is distinguished for the convenience of explanation.

Also, the constituent of the discharge plenum 192 may have the same thickness. Thus, the plenum flange 1920, the plenum seating portion 1922, the plenum body 1924, the plenum extension portion 1928, and the plenum guide surface 1928 may be provided in shapes that extend at the same thickness.

The plenum flange 1920 defines a bottom surface of the of the discharge plenum 192 in the axial direction. That is, the plenum flange 1920 is disposed at the lowermost position in the axial direction on the discharge plenum 192. The plenum flange 1920 has an axial thickness and may be provided in a ring shape extending in the radial direction.

Here, an outer diameter of the plenum flange 1920 corresponds to the inner diameter R of the discharge cover 191. Here, the correspondence means the same or consideration of an assembly tolerance in the inner diameter R of the discharge cover 191.

Accordingly, the plenum flange 1920 may have an outer surface that is in close contact with the inner side of the discharge cover 191. As described above, an upper side of the plenum flange 1920 in the axial direction corresponds to the upper space, and a lower side of the plenum flange 1920 in the axial direction corresponds to the lower space.

Particularly, the plenum flange 1920 functions to close the rear side of the third discharge chamber D3 in the axial direction. That is, as the plenum flange 1920 is seated inside the discharge cover 191, the refrigerant in the third discharge chamber D3 may be prevented from flowing backward in the axial direction.

Also, the inner diameter of the plenum flange 1920 corresponds to a size of the spring assembly 163. In detail, the plenum flange 1920 may extend inward in the radial direction so as to be adjacent the outer surface of the spring support portion 165.

The plenum seating portion 1922 extends inward from the plenum flange 1920 in the radial direction so that the spring assembly 163 is seated. In detail, the plenum seating portion 1922 is bent forward in the axial direction to extend from a radial inner end of the plenum flange 1920 and then is bent again inward to extend in the radial direction.

Thus, the plenum seating portion 1922 has a cylindrical shape of which one end disposed at an axial front side is entirely bent inward in the radial direction. Here, the plenum flange 1920 includes a first plenum seating portion 1922a extending forward in the axial direction and a second plenum seating portion 1922b extending inward from the first plenum seating portion in the radial direction.

The first plenum seating portion 1922a extends forward in the axial direction along the outer surface of the spring support portion 165. Here, a length of the first plenum seating portion 1922a in the axial direction may be less than that of the outer surface of the spring support portion 165 in the axial direction. That is, at least a portion of the spring support portion 165 is seated on the plenum seating portion 1922.

Here, the first plenum seating portion 1922a contacts the friction ring 166. In detail, the friction ring 166 is installed so that at least a portion thereof protrudes from an outer circumferential surface of the spring support portion 165. Thus, when the spring assembly 163 is seated on the plenum seating portion 1922, the friction ring 166 may be in close contact with the first plenum seating portion 1922a.

Particularly, the friction ring 166 may be made of an elastic material such as rubber, which is capable of being deformed in shape by external force. Thus, the friction ring 166 may prevent a gap from occurring between the first plenum seating portion 1922a and the outer circumferential surface of the spring support portion 165.

Also, the spring assembly 163 may be prevented from idling in a circumferential direction by the friction ring 166. Also, the spring support portion 165 may not directly collide with the discharge plenum 192 by the friction ring 166 to minimize an occurrence of striking noise.

The second plenum seating portion 1922b extends inward in the radial direction along the front surface of the spring support portion 165. Here, the second plenum seating portion 1922b contacts a rear end of the partition sleeve 1912.

That is to say, the partition sleeve 1912 extends backward in the axial direction from the inside of the front surface of the chamber portion 1915 to the plenum seating portion 1922. That is, it may be understood that the second plenum seating portion 1922b is disposed between the spring support portion 165 and the partition sleeve 1912 in the axial direction.

Here, the plenum seating portion 1922 and the rear end of the partition sleeve 1912 in the axial direction contact each other. That is, it may be understood that the plenum seating portion 1922 and the partition sleeve 1912 contact each other in the axial direction. Thus, the refrigerant may be prevented from flowing between the second plenum seating portion 1922b and the partition sleeve 1912.

As described above, the third guide groove 1912c is recessed forward in the axial direction from the rear end of the partition sleeve 1912. Thus, the refrigerant may flow between the partition sleeve 1912 and the plenum seating portion 1922 along the third guide groove 1912c. That is, the third guide groove 1912c provides a passage of the refrigerant passing through the partition sleeve 1912 and the second plenum seating portion 1922b.

The plenum body 1924 extends inward from the plenum seating portion 1922 in the radial direction to define the first discharge chamber D1. In detail, the plenum body 1924 extends to be bent forward in the axial direction from the radial inner end of the second plenum seating portion 1922b and then extends to be bent again inward in the radial direction.

Thus, the plenum body 1924 has a cylindrical shape of which one end disposed at a radial front side is entirely bent inward in the radial direction. Here, the plenum body 1924 is classified into a first plenum body 1924a extending forward in the axial direction and a second plenum body 1924b extending inward in the radial direction from the first plenum body 1924a.

The first plenum body 1924a extends forward in the axial direction along the inner surface of the partition sleeve 1912. here, a length of the first plenum body 1924a in the axial direction may be less than that of the partition sleeve 1912 in the axial direction. That is, the first plenum body 1924a is disposed below the partition sleeve 1912.

Here, the first plenum body 1924a and the inner surfaces of the partition sleeve 1912 are in close contact with each other. That is, it may be understood that the plenum body 1924 and the partition sleeve 1912 contact each other in the radial direction. Thus, the refrigerant may be prevented from flowing between the first plenum body 1924a and the partition sleeve 1912.

As described above, the first and second seating grooves 1912a and 1912b are recessed in the inner surface of the partition sleeve 1912. Thus, the refrigerant may flow through the first and second seating grooves 1912a and 1912b between the partition sleeve 1912 and the first plenum body 1924a. That is, the first and second seating grooves 1912a and 1912b define a passage of a refrigerant passing through the partition sleeve 1912 and the first plenum body 1924a.

The second plenum body 1924b extends inward in the radial direction from the front end of the first plenum body 1924a in the axial direction. Here, the second plenum body 1924b is provided in a ring shape that extends inward in the radial direction by using the front end of the first plenum body 1924a in the axial direction as an outer diameter. That is, an opening is defined in a center of the second plenum body 1924b.

Also, the first discharge chamber D1 and the second discharge chamber D2 may be distinguished from each other on the basis of the second plenum body 1924b. In detail, the first discharge chamber D1 is disposed in rear of the second plenum body 1924b in the axial direction, and the second discharge chamber D2 is disposed in front of the second plenum body 1924b in the axial direction.

The plenum extension portion 1926 extends backward in the axial direction from an inner end of the second plenum body 1924b in the radial direction. That is, an opening defined in a central portion of the second plenum body 1924b extends backward in the axial direction to provide a predetermined passage.

As described above, the passage provided by the plenum extension portion 1926 is referred to as a plenum guide portion 1926a. The plenum guide portion 1926a functions as a passage through which the refrigerant in the first discharge chamber D1 flows into the second discharge chamber D2. Particularly, the refrigerant in the first discharge chamber D1 may flow forward in the axial direction along the plenum extension portion 1926a.

Also, the plenum extension portion 1926 may extend backward in the axial direction to contact the spring assembly 163. In detail, the rear end of the plenum extension portion 1926 in the axial direction may contact the front surface of the spring support portion 165. That is to say, the plenum extension portion 1926 may further extend backward in the axial direction than the second plenum seating portion 1922b.

The plenum guide surface 1928 extends forward in the axial direction from the plenum flange 1920. In detail, the plenum guide surface 1928 extends forward in the axial direction from the outer end of the plenum flange 1920 in the radial direction. Here, the plenum guide surface 1928 defines an outer surface of the discharge plenum 192 in the radial direction.

In detail, the plenum guide surface 1928 may be provided in a cylindrical shape extending in the axial direction. Here, an outer diameter of the plenum guide surface 1928 is provided in a size corresponding to the inner diameter R of the discharge cover 191. Here, the correspondence means the same or consideration of an assembly tolerance in the inner diameter R of the discharge cover 191.

Thus, the plenum guide surface 1928 may be installed so that the outer surface is in close contact with the inner side of the discharge cover 191. Thus, the plenum guide surface 1928 is spaced apart from the partition sleeve 1912 and disposed outside the partition sleeve 1912 in the radial direction.

Also, the outer end of the plenum flange 1920 that is in close contact with the inside of the discharge cover 191 may be understood as a portion of the plenum guide surface 1928. Here, the plenum flange 1920 may include an extension portion 1929 further extending outward in the radial direction than the plenum guide surface 1928. The extension portion 1929 of the plenum flange 1920 is provided to prevent the refrigerant from leaking.

Thus, the extension portion 1929 of the plenum flange 1920 may be made of a material that is capable of being in close contact with the inner surface of the discharge cover 191. For example, the extension portion 1929 of the plenum flange 1920 may be made of an elastic material such as rubber. The extension portion 1929 of the plenum flange 1920 may be omitted as an auxiliary constituent for preventing the refrigerant leakage.

Also, the third discharge chamber D3 is disposed on the inner surface of the plenum guide surface 1928. Here, a high-temperature compressed refrigerant flows in the third discharge chamber D3. The plenum guide surface 1928 functions to prevent heat from being transferred from the high-temperature refrigerant to the discharge cover 191.

In other words, the plenum guide surface 1928 is provided so that the side surface of the discharge unit 190 is thicker. That is, the plenum guide surface 1928 may be in close contact with the inner surface of the discharge cover 191 to define one side surface. Thus, the side surface of the discharge unit 190 increases in thickness by the thickness of the plenum guide surface 1928 in the radial direction.

Thus, a much less amount of heat may be conducted and convected in the refrigerant flowing through the discharge space D. That is, the discharge unit 190 may receive a much less amount of heat and thus be maintained at a relatively low temperature. Also, more less heat is transferred to the frame 110 coupled to the discharge unit 190.

Thus, the frame 110 may be maintained at a relatively low temperature. Thus, the heat transferred to the cylinder 120 and the piston 130 disposed inside the frame 110 is reduced. As a result, the temperature of the suction refrigerant is prevented from rising, and the compression efficiency is improved.

When summarizing the description with respect to the shape of the discharge plenum 192, the plenum flange 1920 is provided to extend in the radial direction. Then, the plenum seating portion 1922, the plenum body 1924, and the plenum extension portion 1926 extend from a radial inner end of the plenum flange 1920. Also, the plenum guide surface 1928 extends from the radial outer end of the plenum flange 1920 toward the interior space.

Hereinafter, the fixing ring 193 will be described with reference to FIG. 6.

The fixing ring 193 is inserted into an inner circumferential surface of the discharge plenum 192. Thus, the discharge plenum 192 may be prevented from being separated from the discharge cover 191.

That is, the fixing ring 193 may be understood as a structure for fixing the discharge plenum 192. Particularly, the fixing ring 193 may be inserted into the inner circumferential surface of the plenum body 1924 in a press-pitting manner.

The fixing ring 193 is provided in a cylindrical shape of which axial front and rear surfaces are opened as a whole. Particularly, the fixed ring 193, the fixed ring body 1930 that is in close contact with the inner circumferential surface of the discharge plenum 192, and the first and second fixed ring extension extending radially from the fixed ring body 1930 include first and second fixing extension portions 1932 and 1934.

The fixing ring body 1930 is installed to be in close contact with the first plenum body 1924a. Also, a length of the fixing ring body 1930 in the axial direction may correspond to a length of the first plenum body 1924a in the axial direction.

The first fixing ring extension portion 1932 extends radially inward from an axial front end of the retaining ring body 1930. Thus, the first fixing ring extension portion 1932 may be in close contact with the second plenum body 1924b. The length of the first retaining ring extension 1932 in the radial direction is less than the length of the second plenum body 1924b in the radial direction. That is, the first fixing ring extension portion 1932 is installed to be in close contact with a portion of the second plenum body 1924b.

The second retaining ring extension portion 1934 extends radially outward from an axial rear end of the retaining ring body 1930. Thus, the second fixing ring extension portion 1934 may be in close contact with the second plenum seating portion 1924b. In detail, the second fixing ring extension portion 1934 may be in close contact with a connection portion between the first plenum body 1924a and the second plenum seating portion 1924b.

Also, the second fixing ring extension portion 1934 may be in close contact with the front surface of the spring assembly 163. That is, the second fixing ring extension portion 1934 is disposed between the spring assembly 163 and the discharge plenum 192.

The fixing ring 193 may be made of a material having a thermal expansion coefficient greater than that of the discharge plenum 192. For example, the fixing ring 193 is made of stainless steel, and the discharge plenum 192 is made of an engineering plastic material.

Here, the fixing ring 193 may have a predetermined assembly tolerance with the discharge plenum 192 at room temperature. In detail, the fixing ring 193 is manufactured so that the outer diameter of the fixing ring body 1930 is less than the inner diameter of the first plenum body 1924a at room temperature. Thus, the fixing ring 193 may be relatively easily coupled to the discharge plenum 192.

Also, when the linear compressor 10 is driven, heat is transferred from the refrigerant discharged from the compression space P, and the discharge plenum 192 and the fixing ring 193 are expanded. Here, the fixing ring 193 may be expanded more than the discharge plenum 192 and may contact the discharge plenum 192. Thus, the discharge plenum 192 may strongly contact the discharge cover 191.

Also, the discharge ring 193 prevents the refrigerant from leaking between the discharge cover 191 and the discharge plenum 192 because the discharge plenum 192 strongly contacts the discharge cover 191.

Hereinafter, a flow of the refrigerant in the discharge space D will be described in detail based on the above-described structure.

FIG. 9 is a view illustrating a portion ‘B’ of FIG. 3 together with a flow of the refrigerant.

As illustrated in FIG. 9, the discharge space D is divided into a plurality of spaces. As described above, the discharge space D includes the first discharge chamber D1, the second discharge chamber D2, and the third discharge chamber D3.

Also, the first, second and third discharge chambers D1, D2 and D3 are defined by the discharge cover 191 and the discharge plenum 192. The first and second discharge chambers D1 and D3 are defined by the discharge plenum 192, and the second and third discharge chambers D2 and D3 are provided between the discharge plenum 192 and the discharge cover 191.

Also, the second discharge chamber D2 is defined in the axial direction of the first discharge chamber D1, and the third discharge chamber D3 is defined outward the first and second discharge chambers D1 and D2 in the radial direction.

Also, the discharge cover 191, the discharge plenum 192, and the fixing ring 193 contact each other and are coupled to each other. Also, the discharge valve assembly 160 may be seated at a rear side of the discharge plenum 192.

When a pressure in the compression space P is equal to or greater than that in the discharge space D, the valve spring 164 is elastically deformed toward the discharge plenum 192. Thus, the discharge valve 161 may open the compression space P so that the compressed refrigerant inside the compression space P flows to the discharge space D. The refrigerant discharged from the compression space P by opening the discharge valve 161 passes through the valve spring 164 and then is guided to the first discharge chamber D1.

The refrigerant guided to the first discharge chamber D1 passes through the plenum guide portion 1926a and then is guided to the second discharge chamber D2. Here, the refrigerant in the first discharge chamber D1 passes through the plenum guide portion 1926a having a narrow cross-sectional area and then is discharged to the second discharge chamber D2 having a large cross-sectional area. Thus, noise due to pulsation of the refrigerant may be remarkably reduced.

The refrigerant guided to the second discharge chamber D2 moves backward in the axial direction along the first guide groove 1912a to move in the circumferential direction along the second guide groove 1912b. Also, the refrigerant moving in the circumferential direction along the second guide groove 1912b passes through the third guide groove 1912c and is guided to the third discharge chamber D3.

Here, the refrigerant in the second discharge chamber D2 passes through the first guide groove 1912a, the second guide groove 1912b, and the third guide groove 1912c having a narrow sectional area and then is discharged to the third discharge chamber D3 having a wide sectional area. Thus, the noise due to the pulsation of the refrigerant may be reduced once more.

Here, the third discharge chamber D3 is provided to communicate with the cover pipe 195. Thus, the refrigerant guided to the third discharge chamber D3 flows to the cover pipe 195. Also, the refrigerant guided to the cover pipe 195 may be discharged to the outside of the linear compressor 10 through the discharge pipe 105.

As described above, the refrigerant discharged from the compression space P may flow into the discharge space D defined in the discharge unit 190. Particularly, the refrigerant discharged in the compression space P may sequentially pass through the first discharge chamber D1, the second discharge chamber D2, and the third discharge chamber D3.

Here, the linear compressor 10 is provided with a structure that functions as a bearing using a refrigerant. Hereinafter, the refrigerant used as the bearing is referred to as a bearing refrigerant. The bearing refrigerant may correspond to a portion of the refrigerant flowing in the discharge space D. Particularly, the bearing refrigerant may correspond to a portion of the refrigerant flowing into the third discharge chamber D3.

A bearing refrigerant passage X through which the bearing refrigerant flows is provided in the discharge unit 190. Here, the bearing refrigerant passage X may be understood as a passage or flow path through which the bearing refrigerant flows. Particularly, the bearing refrigerant passage X is provided so that the bearing refrigerant effectively flows to the gas hole 1106.

First, a flow of the bearing refrigerant supplied to the frame 110, the cylinder 120, and the piston 130 by flowing into the gas hole 1106 through the bearing refrigerant passage X will be described.

FIG. 10 is a view illustrating the frame of the linear compressor together with the flow of the refrigerant according to the first embodiment. FIG. 10 illustrates a configuration in which unnecessary portions are omitted to describe the flow of the bearing refrigerant.

As illustrated in FIG. 10, the frame 110 includes a frame connection portion 113 extending to be inclined from the frame flange 112 to the frame body 111.

Here, a plurality of the frame connection portions 113 are provided and are arranged at equal intervals in a circumferential direction. For example, three frame connection portions 113 may be provided and may be arranged at an interval of about 120 degrees in the circumferential direction.

A gas passage 1130 for guiding the refrigerant discharged from the compression space P to the cylinder 120 is provided in the frame connection portion 113. Here, the gas passage 1130 may be provided only in one of the plurality of frame connection portions 113. Also, it is understood that the frame connection portion 113 on which the gas passage 1130 is not provided is provided to prevent the frame 110 from being deformed.

The gas passage 1130 may pass through the inside of the frame connection portion 113. Also, the gas passage 1130 may be provided to be inclined in correspondence with the frame connection portion 113. Particularly, the gas passage 1130 may extend from the frame flange 112 up to the frame body 111 via the frame connection portion 113.

In detail, one end of the gas passage 1130 is connected to the gas hole 1106. As described above, the gas hole 1106 is recessed backward from the discharge frame surface 1120 in the axial direction. Also, the gas filter 1107 may be installed at one side of the gas hole 1106 communicating with the gas passage 1130.

For example, the gas hole 1106 may have a cylindrical shape. Also, the gas filter 1107 may be provided as a circular filter and disposed at a rear end of the gas hole 1106 in the axial direction.

Then, the other end of the gas passage 1130 communicate with an outer peripheral surface of the cylinder 120. Particularly, the gas passage 1130 may be provided to communicate with the gas inflow portion 1200 provided in the outer circumferential surface of the cylinder 120.

The gas inflow portion 1200 may be recessed inward from an outer circumferential surface of the cylinder 120 in the radial direction. Particularly, the gas inflow portion 1200 may be provided to have a surface area that gradually decreases inward in the radial direction. Thus, an inner end of the gas inflow portion 1200 in the radial direction may provide a tip portion.

Also, the gas inflow portion 1200 extends in the circumferential direction along an outer circumferential surface of the cylinder 120 and thus has a circular shape. Also, the gas inflow portion 1200 may be provided in plurality that are spaced apart from each other in the axial direction. For example, two gas inflow portions 1200 may be provided, and one gas inflow portion 1200 may be disposed to communicate with the gas passage 1130.

A cylinder filter member (not shown) may be installed on the gas inflow portion 1200. The cylinder filter member (not shown) may prevent foreign substances having a predetermined size or more from being introduced into the cylinder 120. Also, the cylinder filter member performs a function of adsorbing an oil component contained in the refrigerant.

Also, the cylinder 120 further includes a cylinder nozzle 1205 extending inward from the gas inflow portion 1200 in the radial direction. Here, the cylinder nozzle 1205 may extend up to the inner circumferential surface of the cylinder 120. That is, the cylinder nozzle 1205 may be understood as a portion in communication with the outer circumferential surface of the piston 130.

Particularly, the cylinder nozzle 1205 extends from the radial inner end of the gas inflow portion 1200. That is, the cylinder nozzle 1205 may has a very small size.

A flow of the bearing refrigerant through the structure will be described. A portion of the refrigerant flowing from the discharge space D, i.e., the bearing refrigerant flows to the gas hole 1106 through the bearing refrigerant passage X.

The bearing refrigerant flowing into the gas hole 1106 through the bearing refrigerant passage X passes through the gas filter 1107 to flow into the gas passage 1130. Also, the bearing refrigerant may flow to the gas inflow portion 1200 through the gas passage 1130 and then be distributed along the outer surface of the cylinder 120.

Also, a portion of the bearing refrigerant may flow to the outer surface of the piston 130 through the cylinder nozzle 1205. The bearing refrigerant flowing to the outer surface of the piston 130 may be distributed along the outer surface of the piston 130.

As described above, fine spaces are defined between the piston 130 and the cylinder 120 through the bearing refrigerant distributed on the outer surface of the piston 130. That is, the bearing refrigerant may provide lifting force to the piston 130 to perform a function of a gas bearing for the piston 130.

Thus, abrasion of the piston 130 and the cylinder 120 due to the reciprocation motion of the piston 130 may be prevented. That is, the bearing function may be performed without using oil through the bearing refrigerant.

Referring to FIGS. 8 and 9, the discharge plenum 192 is provided with a penetrated bearing refrigerant hole 1923. In detail, the bearing refrigerant hole 1923 is defined to pass through the plenum flange 1920. Here, the bearing refrigerant passage X is provided to pass through the bearing refrigerant hole 1923. That is, the bearing refrigerant may pass through the bearing refrigerant hole 1923 to flow from the discharge unit 190 to the gas hole 1106.

Here, the bearing refrigerant hole 1923 is defined in front of the gas hole 1106 in the axial direction. That is, the bearing refrigerant passage X is defined in an axial front of the gas hole 1106. Also, the bearing refrigerant may flow rearward in the axial direction along the bearing refrigerant passage X.

Also, the bearing refrigerant passage X according to an embodiment may be provided to extend toward the gas hole 1106. Here, the bearing refrigerant passage X may be provided to extend in the axial direction so that the bearing refrigerant flows in the axial direction.

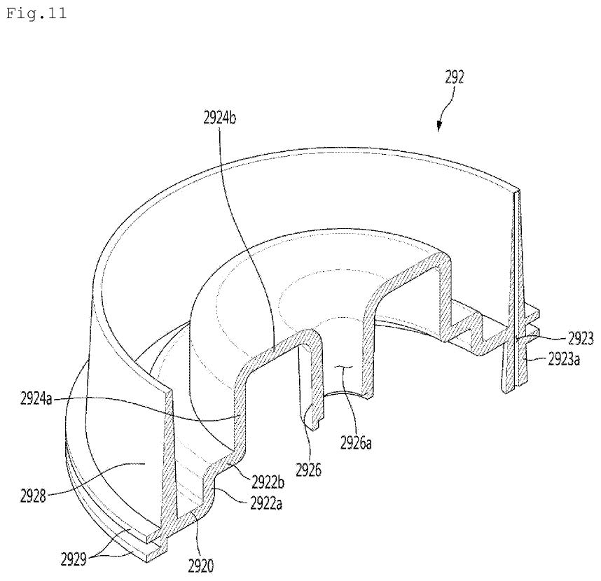

Particularly, at least a portion of the bearing refrigerant passage X may be provided inside the gas hole 1106. That is, the bearing refrigerant passage X is provided to extend from the third discharge chamber D3 to the gas hole 1106. The bearing refrigerant passage X having the above-described shape is exemplarily illustrated in FIGS. 11 to 14.

FIGS. 11 to 14 illustrate exemplary bearing refrigerant passages X corresponding to the second, third, and fourth embodiments. Here, in each embodiment, the constituent is modified, or a new constituent is added so that the bearing refrigerant passages X having different shapes are provided. All descriptions with respect to the same constituent as described above will be cited.

Also, for convenience of understanding, reference numerals included in the discharge plenum are separately described for each embodiment. However, for the same constituent, reference numerals that are distinguished from the same name are attached, and all the descriptions are cited.

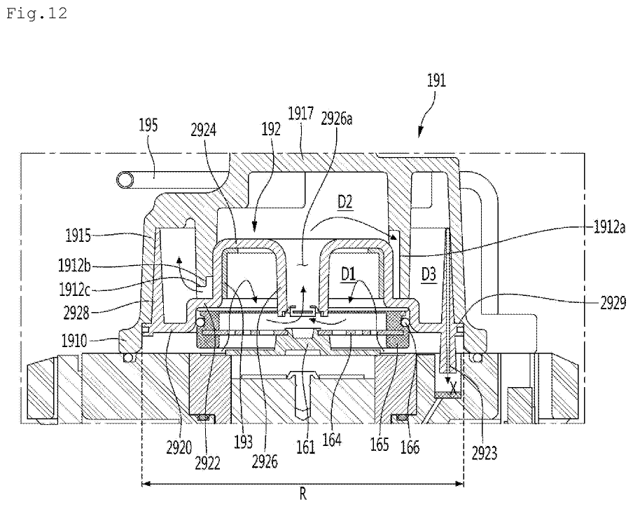

FIG. 11 is a view illustrating a state in a discharge plenum of a linear compressor is cut according to a second embodiment, and FIG. 12 is a view illustrating a portion of the linear compressor together with a flow of a refrigerant according to the second embodiment.

As illustrated in FIGS. 11 and 12, a bearing refrigerant passage X according to the second embodiment is provided to pass through a discharge plenum 292. Particularly, the bearing refrigerant passage X is provided to pass through a plenum guide surface 2928.

In detail, the discharge plenum 292 includes a plenum flange 2920 extending in a radial direction. Also, the plenum guide surface 2928 extends axially from the plenum flange 2920.

The plenum flange 2920 includes a bearing refrigerant hole 2323 defined to be penetrated. Also, the plenum guide surface 2928 extends from the plenum flange 2920 to accommodate the bearing refrigerant hole 229. Particularly, the plenum guide surface 2928 may extend from a radial outer end of the plenum flange 2920.

The plenum flange 2920 is further provided with an extension portion 2929 further protruding in the radial direction than the plenum guide surface 2928. The extension portion 2929 may be provided in plurality, which are spaced apart from each other in the axial direction, to prevent the refrigerant from leaking. Since a plurality of the extension portions 2929 are provided, the leakage of the refrigerant may be more reliably prevented.

Here, the plenum guide surface 2928 extends forward and backward from the plenum flange 2920 in the axial direction.

In detail, a portion of the plenum guide surface 2928 extending axially forward from the plenum flange 2920 is disposed to be in close contact with the inner surface of the discharge cover 191. Particularly, the plenum guide surface 2928 may extend in the axial direction in the cylindrical shape.

Also, a portion of the plenum guide surface 2928 extending radially backward from the plenum flange 2920 extends to the inside of the gas hole 1106 as illustrated in FIG. 12. Particularly, the plenum guide surface 2928 may extend axially backward in a rod shape.

As a result, the bearing refrigerant moves axially forward along the plenum guide surface 2928 extending axially forward from the third discharge chamber D3. Also, the refrigerant flows axially backward up to the gas hole 1106 along a bearing refrigerant passage X provided to pass through the plenum guide surface 2928.

As the bearing refrigerant passage X is provided up to the inside of the gas hole 1106, the bearing refrigerant may not flow to the outside of the gas hole 1106, but flow directly along the gas passage 1130.

Also, as a flow path of the bearing refrigerant extends as described above, a temperature of the bearing refrigerant may be reduced. Accordingly, an amount of heat transferred to the constituents such as the frame 110 and the like may be reduced by the bearing refrigerant.

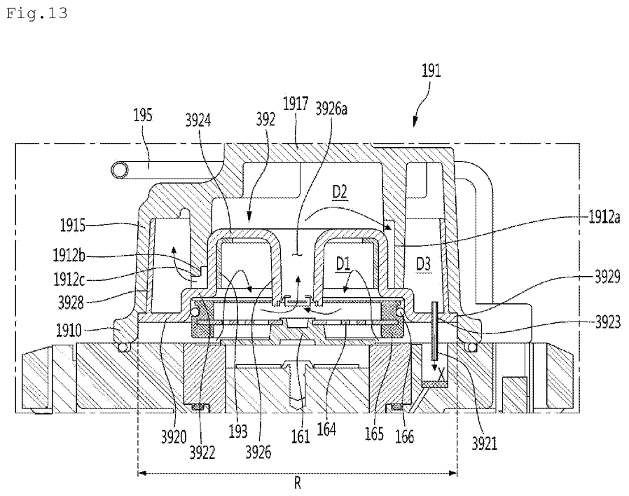

FIG. 13 is a view illustrating a portion of a linear compressor together with a flow of a refrigerant according to a third embodiment.

As illustrated in FIG. 13, a bearing refrigerant passage X according to the third embodiment is provided to pass through a bearing refrigerant pipe 3921 inserted in a discharge plenum 392.

In detail, the discharge plenum 392 includes a plenum flange 3920 extending in a radial direction. Also, the plenum flange 3920 includes a bearing refrigerant hole 3923 defined to be penetrated. The bearing refrigerant hole 3923 is provided in front of the gas hole 1106 in an axial direction.

Also, the bearing refrigerant pipe 3921 is disposed to be inserted into the bearing refrigerant hole 3923. The bearing refrigerant pipe 3921 is provided in the form of a pipe extending to one side. Referring to FIG. 13, the bearing refrigerant pipe 3921 is disposed to be inserted into the bearing refrigerant hole 3923 so as to extend in the axial direction.

Particularly, the bearing refrigerant pipe 3921 is disposed to extend axially forward and backward with respect to the plenum flange 3920. Here, the bearing refrigerant pipe 3921 is installed to extend toward the gas hole 1106. In addition, the bearing refrigerant pipe 3921 is installed so as to be disposed inside the gas hole 1106.

Here, the bearing refrigerant pipe 3921 is made of a material having thermal conductivity less than that of the discharge plenum 392. That is, the bearing refrigerant pipe 3921 is made of a material different from the discharge plenum 392. For example, the bearing refrigerant pipe 3921 may be made of a material such as rubber.

As a result, the bearing refrigerant moves axially forward along the bearing refrigerant pipe 3921 extending axially forward from the third discharge chamber D3. Also, the refrigerant flows axially backward up to the gas hole 1106 along a bearing refrigerant passage X provided to pass through the bearing refrigerant pipe 3921.

As the bearing refrigerant passage X is provided up to the inside of the gas hole 1106, the bearing refrigerant may not flow to the outside of the gas hole 1106, but flow directly along the gas passage 1130. Particularly, since the bearing refrigerant pipe 3921 is made of the material having the low thermal conductivity, heat transferred from the bearing refrigerant pipe 3921 to the outside may be further reduced.

Also, as a flow path of the bearing refrigerant extends as described above, a temperature of the bearing refrigerant may be reduced. Accordingly, an amount of heat transferred to the constituents such as the frame 110 and the like may be reduced by the bearing refrigerant.

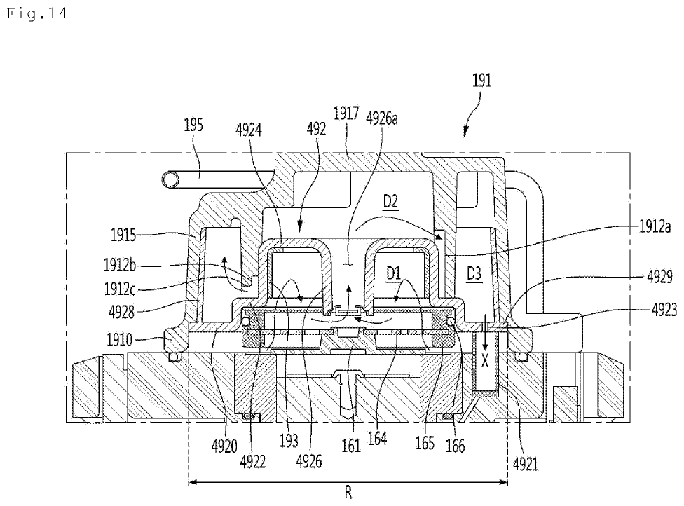

FIG. 14 is a view illustrating a portion of a linear compressor together with a flow of a refrigerant according to a fourth embodiment.

As illustrated in FIG. 14, a bearing refrigerant passage X according to the fourth embodiment is provided to connect a discharge plenum 492 to a gas hole 1106.

In detail, the discharge plenum 492 includes a plenum flange 4920 extending in a radial direction. Also, the plenum flange 4920 includes a bearing refrigerant hole 4923 defined to be penetrated. The bearing refrigerant hole 4923 is provided in front of the gas hole 1106 in an axial direction.

Also, the linear compressor further includes a bearing insertion pipe 4921 installed to be inserted into a gas hole 1106. The bearing insertion pipe 4921 is provided in the form of a pipe extending to one side. Referring to FIG. 14, the bearing insertion pipe 4921 is disposed to be inserted into the gas hole 1106 so as to extend in an axial direction.

Particularly, an outer diameter of the bearing insertion pipe 4921 may be formed to correspond to the inner diameter of the gas hole 1106. Accordingly, the bearing insertion pipe 4921 may be installed to be press-fitted into the gas hole 1106.

Also, the bearing insertion pipe 4921 extends axially forward so as to contact one side of a plenum flange 4920 in which the bearing refrigerant hole 4923 is defined. That is, the bearing insertion pipe 4921 may be understood as being disposed between the bearing refrigerant hole 4923 and the gas hole 1106.

Thus, a bearing refrigerant passage X is provided to pass through the bearing refrigerant hole 4923 and the bearing insertion pipe 4921.

As a result, the bearing refrigerant flows radially backward from a third discharge chamber D3 by passing through the discharge plenum 492 through the refrigerant hole 4923. Also, the bearing refrigerant flows axially backward up to the gas hole 1106 along the bearing insertion pipe 4921.

As the bearing refrigerant passage X is provided up to the inside of the gas hole 1106, the bearing refrigerant may not flow to the outside of the gas hole 1106, but flow directly along the gas passage 1130.

The linear compressor including the above-described constituents according to the embodiment may have the following effects.

The bearing refrigerant provided from the discharge unit to the cylinder and the piston by passing through the frame may directly flow to the gas hole to prevent the high-temperature refrigerant from flowing along the front surface of the frame.

Therefore, the heat transferred to the frame may be reduced to reduce the heat transfer to the cylinder and the piston, which are disposed inside the frame. As a result, the heat transferred to the suction refrigerant may be reduced to improve the compression efficiency.

Particularly, the bearing refrigerant passage extending toward the gas hole may be provided in the discharge unit to allow the bearing refrigerant to more effectively flow to the gas hole. That is, the contact between the bearing refrigerant and other constituents may be minimized to prevent the heat from being transferred.

In addition, the bearing refrigerant passage may be dispose in front of the gas hole in the axial direction. Therefore, the bearing refrigerant may flow at the relatively less distance and be simplified in structure to prevent the heat from being transferred to other constituents.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A linear compressor comprising:
a cylinder that defines a compression space configured to compress a refrigerant;
a frame that receives the cylinder; and
a discharge unit that defines a discharge space configured to discharge the refrigerant from the compression space,
wherein the frame comprises:
a discharge frame surface connected to the discharge unit; and
a gas hole defined at the discharge frame surface, and
wherein the discharge unit comprises a bearing refrigerant passage extending toward the gas hole of the frame and configured to permit a portion of the refrigerant to flow from the discharge space to the gas hole.

2. The linear compressor according to claim 1, wherein at least a portion of the bearing refrigerant passage is disposed in the gas hole.

3. The linear compressor according to claim 1, wherein the discharge unit comprises:
a discharge cover connected to the discharge frame surface; and
a discharge plenum received in the discharge cover and including a bearing refrigerant hole that defines at least a portion of the bearing refrigerant passage.

4. The linear compressor according to claim 3, wherein the discharge plenum includes a plenum flange extending in a radial direction and received in the discharge cover, and
wherein the bearing refrigerant hole is defined at the plenum flange.

5. The linear compressor according to claim 4, wherein the discharge plenum includes a plenum guide surface extending from the plenum flange and defining the bearing refrigerant hole, and
wherein the bearing refrigerant passage extends through the plenum guide surface.

6. The linear compressor according to claim 5, wherein the plenum guide surface extends from opposite sides of the plenum flange.

7. The linear compressor according to claim 4, further comprising a bearing refrigerant pipe that is inserted into the bearing refrigerant hole and extends toward the gas hole,
wherein the bearing refrigerant passage extends through the bearing refrigerant pipe.

8. The linear compressor according to claim 4, further comprising a bearing insertion pipe that is inserted into the gas hole and contacts one side of the plenum flange that defines the bearing refrigerant hole,
wherein the bearing refrigerant passage extends through the bearing refrigerant hole and the bearing insertion pipe.

9. The linear compressor according to claim 3, wherein the discharge plenum includes a plenum guide surface that contacts an inner surface of the discharge cover, and
wherein the bearing refrigerant passage extends through the plenum guide surface.

10. The linear compressor according to claim 9, wherein the plenum guide surface extends into the gas hole.

11. The linear compressor according to claim 1, wherein the discharge unit comprises:
a discharge cover connected to the discharge frame surface; and
a discharge plenum received in the discharge cover,
wherein the linear compressor further comprises a bearing refrigerant pipe extending through the discharge plenum and defining the bearing refrigerant passage.

12. The linear compressor according to claim 11, wherein the bearing refrigerant pipe has thermal conductivity less than the discharge plenum.

13. The linear compressor according to claim 1, further comprising a bearing insertion pipe that is inserted into the gas hole and defines at least a portion of the bearing refrigerant passage.

14. The linear compressor according to claim 13, wherein the discharge unit comprises:
a discharge cover connected to the discharge frame surface; and
a discharge plenum received in the discharge cover and defining a bearing refrigerant hole that extends through the discharge plenum,
wherein the bearing insertion pipe is disposed between the bearing refrigerant hole and the gas hole.

15. The linear compressor according to claim 1, wherein the frame comprises a gas passage that extends between the gas hole and the cylinder, and
wherein a portion of the refrigerant that flows into the discharge space passes through the bearing refrigerant passage, the gas hole, and the gas passage to flow into the cylinder.

16. A linear compressor comprising:
a piston configured to reciprocate in an axial direction;
a cylinder configured to receive the piston;
a frame configured to receive the cylinder; and
a discharge unit that defines a discharge space configured to discharge a refrigerant that is compressed by the piston flows, the discharge unit being connected to an axial side of the frame,
wherein the frame comprises:
a discharge frame surface connected to the discharge unit, the discharge frame surface defining an axial surface; and
a gas hole defined at the discharge frame surface and extending in the axial direction, and
wherein the discharge unit comprises a bearing refrigerant passage that is defined at an axial side of the gas hole and configured to permit a portion of the refrigerant to flow from the discharge space to the gas hole.

17. The linear compressor according to claim 16, wherein the bearing refrigerant passage extends in the axial direction so that the portion of the refrigerant flows in the axial direction.

18. The linear compressor according to claim 17, wherein the bearing refrigerant passage extends in the axial direction and is configured to be at least partially disposed in the gas hole.

19. The linear compressor according to claim 16, wherein the discharge unit comprises:
a discharge cover connected to the discharge frame surface; and
a discharge plenum received in the discharge cover and configured to divide the discharge space into a plurality of discharge chambers,
wherein the bearing refrigerant passage extends through the discharge plenum.

20. The linear compressor according to claim 19, wherein the plurality of discharge chambers comprise:
a first discharge chamber configured to permit the refrigerant that is compressed by the piston to flow;
a second discharge chamber disposed in an axial side of the first discharge chamber and configured to permit the refrigerant that passes through the first discharge chamber to flow; and
a third discharge chamber disposed radially around the first and second discharge chambers and configured to permit the refrigerant that passes through the second discharge chamber to flow,
wherein the bearing refrigerant passage is configured to permit a portion of the refrigerant that flows into the third discharge chamber to flow to the gas hole.
